(19) United States
(12) Patent Application Publication
(10) Pub. No.: US 2026/0079561 A1
(43) Pub. Date: Mar. 19, 2026

(54) ELECTRONIC DEVICE COMPRISING DISPLAY OPERATING IN STATE FOR LOWER POWER CONSUMPTION, AND METHOD THEREFOR

(71) Applicant: Samsung Electronics Co., Ltd., Suwon-si (KR)

(72) Inventors: Jongkon BAE, Suwon-si (KR); Jinhyun KIM, Suwon-si (KR); Hyoungsup KIM, Suwon-si (KR); Byungduk YANG, Suwon-si (KR); Jaesung LEE, Suwon-si (KR); Jongsuk LEE, Suwon-si (KR)

(21) Appl. No.: 19/402,225

(22) Filed: Nov. 26, 2025

Related U.S. Application Data
(63) Continuation of application No. PCT/KR2024/006093, filed on May 7, 2024.

(30) Foreign Application Priority Data
Jul. 6, 2023 (KR) 10-2023-0087742
Aug. 29, 2023 (KR) 10-2023-0113945

(51) Int. Cl. G06F 1/3234; G06F 1/3218; G06F 3/0484; G06F 3/0488; H04M 1/73

(52) U.S. Cl. CPC G06F 1/3265; G06F 1/3218; G06F 3/0484; G06F 3/0488; H04M 1/73

(57) ABSTRACT

An electronic device is provided. The electronic device includes a display, memory, a sensor, and one or more processors including a first processing circuit, a second processing circuit and at least one third processing circuit, wherein the first processing circuitry is configured to store, in the memory, candidate images for at least partially changing of a screen to be displayed on the display operating in a state for lower power consumption, wherein storing of the candidate images is performed for maintaining an inactive state of the first processing circuitry while the display operates in the state for lower power consumption, and after the candidate images are stored, switch a state of the first processing circuitry to the inactive state, and wherein the at least one third processing circuitry is configured to, while the inactive state of the first processing circuitry is maintained, control the second processing circuitry to obtain a candidate image corresponding to sensing data obtained via the sensor from among the candidate images, from the memory, and control the second processing circuitry to transmit data associated with the candidate image to the display for at least partially changing the screen being displayed on the display operating in the state for lower power consumption based on the candidate image.

### CROSS-REFERENCE TO RELATED APPLICATION(S)

This application is a continuation application, claiming priority under 35 U.S.C. § 365 (c), of an International application No. PCT/KR2024/006093, filed on May 7, 2024, which is based on and claims the benefit of a Korean patent application number 10-2023-0087742, filed on Jul. 6, 2023, in the Korean Intellectual Property Office, and of a Korean patent application number 10-2023-0113945, filed on Aug. 29, 2023, in the Korean Intellectual Property Office, the disclosure of each of which is incorporated by reference herein in its entirety.

### BACKGROUND

### 1. Field

The disclosure relates to an electronic device comprising a display operating as a state for lower power consumption.

### 2. Description of Related Art

An electronic device may comprise a display to provide visual information and/or visual data. The electronic device may include a rechargeable battery. The electronic device may display an image on the display operating as (or operating with) a state for lower power consumption to reduce power consumption provided to the display using the rechargeable battery.

The above information is provided as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device comprising a display operating as a state for lower power consumption.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, a sensor, and one or more processors communicatively coupled to the display, the memory, and the sensor, the one or more processors including first processing circuitry, second processing circuitry, and at least one third processing circuitry, wherein the instructions, when executed by the first processing circuitry, cause the first processing circuitry to store, in the memory, candidate images for at least partially changing a screen to be displayed on the display operating in a state for lower power consumption, wherein storing of the candidate images is performed for maintaining an inactive state of the first processing circuitry while the display operates in the state for lower power consumption, and after the candidate images are stored, switch a state of the first processing circuitry to the inactive state, and wherein the instructions, when executed by the at least one third processing circuitry, cause the at least one third processing circuitry to, while the inactive state of the first processing circuitry is maintained, control the second processing circuitry to obtain a candidate image corresponding to sensing data obtained via the sensor from among the candidate images, from the memory, and control the second processing circuitry to transmit data associated with the candidate image to the display for at least partially changing the screen being displayed on the display operating in the state for lower power consumption based on the candidate image.

In accordance with another aspect of the disclosure, a method is provided. The method is executed in an electronic device comprising a display, memory, a sensor, and one or more processors including first processing circuitry, second processing circuitry, and at least one third processing circuitry. The method includes storing, by the first processing circuitry, in the memory, candidate images for at least partially changing of a screen to be displayed on the display operating as a state for lower power consumption, wherein storing of the candidate images is performed for maintaining an inactive state of the first processing circuitry while the display operates as the state. The method includes, after the candidate images are stored, switching, by the first processing circuitry, a state of the first processing circuitry to the inactive state. The method includes, while the inactive state of the first processing circuitry is maintained, controlling, by the at least one third processing circuitry, the second processing circuitry to obtain a candidate image corresponding to sensing data obtained via the sensor from among the candidate images, from the memory. The method includes, while the inactive state of the first processing circuitry is maintained, controlling, by the at least one third processing circuitry, the second processing circuitry to transmit data associated with the candidate image to the display for at least partially changing the screen being displayed on the display operating as the state based on the candidate image.

In accordance with another aspect of the disclosure, an electronic device is provided. The electronic device includes a display, volatile memory, and a sensor, and one or more processors, wherein the instructions, when executed by the one or more processors individually or collectively, cause the electronic device to, in response to occurrence of an event in which the display operates in a state for lower power consumption, access the memory, by using power within a first range, before the display operates in the state for lower power consumption, after accessing the volatile memory, obtain sensing data from the sensor by using a power within a second range lower than the first range, while displaying a screen on the display operating in the state for lower power consumption, and while a power used by the one or more processors is maintained within the second range, cause a visual object corresponding to the sensing data to appear within the screen displayed on the display operating in the state for lower power consumption, based on accessing the volatile memory in response to the sensing data.

In accordance with another aspect of the disclosure, a method is provided. The method is executed in an electronic device comprising a display, memory, a sensor, and one or more processors. The method includes, in response to occurrence of an event in which the display operates as a state for lower power consumption, accessing, by the one or more processors, the memory, by using power within a first range, before the display operates in the state for lower power consumption. The method includes, after accessing the memory, obtaining, by the one or more processors, sensing data from the sensor by using a power within a second range lower than the first range, while displaying a screen on the display operating in the state for lower power consumption. The method includes, while a power used by the one or more processors is maintained within the second range, causing, by the one or more processors, a visual object corresponding to the sensing data to appear within the screen displayed on the display operating in the state for lower power consumption, based on accessing the memory in response to the sensing data.

In accordance with another aspect of the disclosure, an electronic device is provided. The electronic device includes a display. The electronic device includes memory. The electronic device includes a sensor. The electronic device includes one or more processors. The one or more processors is configured to store, in the memory, candidate images for at least partially changing of a screen to be displayed on the display operating as a state for lower power consumption, by using a power within a first range. The one or more processors is configured to, while one or more processors operates by using a power within a second range lower than the first range after storing the candidate images, obtain, from the memory, a candidate image corresponding to sensing data obtained through the sensor from among the candidate images, and at least partially change the screen displayed on the display operating in the state for the lower power consumption by transmitting, to the display, data associated with the candidate image.

In accordance with another aspect of the disclosure, a method is provided. The method is executed in an electronic device comprising a display, memory, a sensor, and one or more processors. The method includes storing, by the one or more processors, in the memory, candidate images for at least partially changing of a screen to be displayed on the display operating as a state for lower power consumption, by using a power within a first range. The method includes, while one or more processors operates by using a power within a second range lower than the first range after storing the candidate images, obtaining, by the one or more processors, from the memory, a candidate image corresponding to sensing data obtained through the sensor from among the candidate images, and at least partially changing, by the one or more processors, the screen displayed on the display operating in the state for the lower power consumption by transmitting, to the display, data associated with the candidate image.

In accordance with another aspect of the disclosure, an electronic device is provided. The electronic device includes a display. The electronic device includes memory. The electronic device includes a sensor. The electronic device includes one or more processors. The one or more processors is configured to store, in the memory, candidate images for at least partially changing of a screen to be displayed on the display operating as a state for lower power consumption by using a power within a first range. The one or more processors is configured to, after storing the candidate images, obtain sensing data through the sensor, while the screen is displayed on the display operating in the state for the lower power consumption and power within a second range lower than the first range is consumed by the one or more processors. The one or more processors is configured to obtain, from the memory, a candidate image corresponding to the sensing data from among the candidate images to maintain consumption of the power within the second range. The one or more processors is configured to, while the consumption of the power within the second range is maintained, at least partially change the screen displayed on the display operating as the lower power state based on the candidate image.

In accordance with another aspect of the disclosure, a method is provided. The method is executed in an electronic device comprising a display, memory, a sensor, and one or more processors. The method includes storing, by the one or more processors, in the memory, candidate images for at least partially changing of a screen to be displayed on the display operating as a state for lower power consumption by using a power within a first range. The method includes, after storing the candidate images, obtaining, by the one or more processors, sensing data through the sensor, while the screen is displayed on the display operating in the state for the lower power consumption and power within a second range lower than the first range is consumed by the one or more processors. The method includes obtaining, by the one or more processors, from the memory, a candidate image corresponding to the sensing data from among the candidate images to maintain consumption of the power within the second range. The method includes, while the consumption of the power within the second range is maintained, at least partially changing, by the one or more processors, the screen displayed on the display operating as the lower power state based on the candidate image.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a partial change of a screen displayed on a display operating as a state for lower power consumption according to an embodiment of the disclosure;

FIG. 2 is a simplified block diagram of an electronic device according to an embodiment of the disclosure;

FIG. 3 illustrates a method of at least partially changing a screen displayed on a display operating as a state for lower power consumption based on storing candidate images according to an embodiment of the disclosure;

FIG. 4 illustrates a method of at least partially changing a screen displayed on a display operating as a state for lower power consumption based on sensing data according to an embodiment of the disclosure;

FIG. 5 illustrates a method of upscaling an image to be displayed on a display operating as a state for lower power consumption according to an embodiment of the disclosure;

FIG. 6 illustrates a method of displaying a screen having a background partially changed in accordance with a cycle on a display operating as a state for lower power consumption by using address information changed in accordance with the cycle according to an embodiment of the disclosure;

FIG. 7 illustrates a method of providing an animation through a screen displayed on a display operating as a state for lower power consumption based on executing an interpolation of images according to an embodiment of the disclosure;

FIG. 8 illustrates a method of changing a brightness level of a screen displayed on a display operating as a state for lower power consumption according to an embodiment of the disclosure;

FIG. 9 illustrates a method of changing a color temperature of a screen displayed on a display operating as a state for lower power consumption according to an embodiment of the disclosure;

FIG. 10 is a block diagram of an electronic device in a network environment according to various embodiments according to an embodiment of the disclosure; and

FIG. 11 is a block diagram of a display module according to various embodiments according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

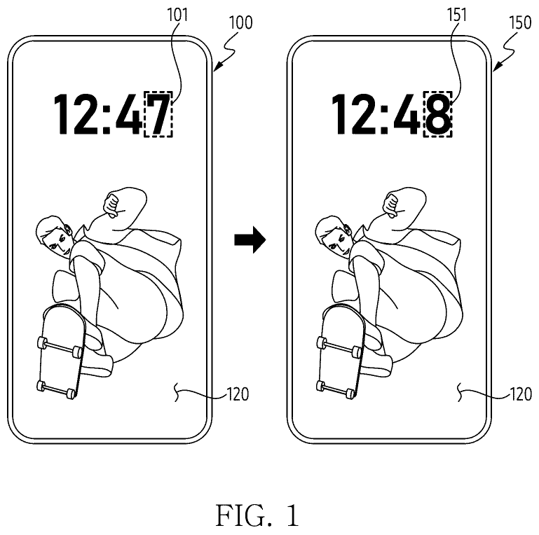

FIG. 1 illustrates an example of a partial change of a screen displayed on a display operating as a state for lower power consumption according to an embodiment of the disclosure.

Referring to FIG. 1, an electronic device may comprise a display. The display may operate as (or operate with) a first state for lower power consumption.

For example, the electronic device may display a screen 120 on the display operating as the first state. The screen 120 displayed on the display operating as the first state may be at least partially changed. For example, after one minute, a state 100 of the screen 120 displayed on the display operating as the first state may be changed to a state 150.

The electronic device may change a portion of the screen 120 for the change from the state 100 to the state 150. For example, an image 101 (or a visual object 101) may be replaced with an image 151 (or a visual object 151) in accordance with the change from the state 100 to the state 150. Executing, by using first processing circuitry of the electronic device to be exemplified below, at least partially changing of the screen 120 such as changing the image 101 to the image 151 may cause relatively higher power consumption.

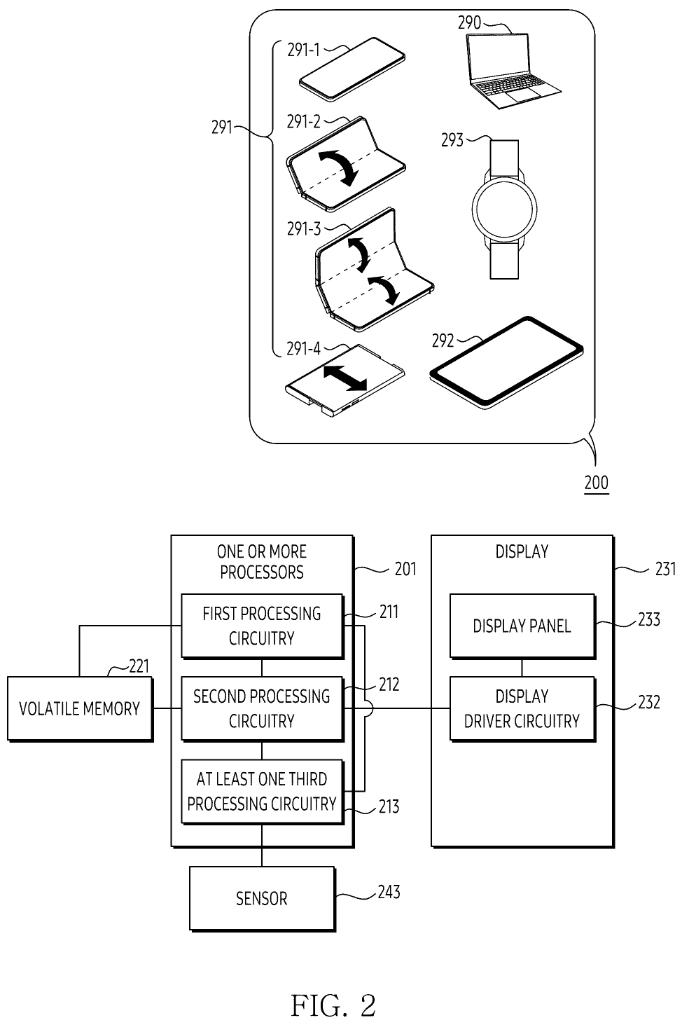

In the description of FIGS. 2 to 9, an electronic device 200 to be exemplified may reduce power consumption by executing, by using at least one third processing circuitry of the electronic device to be exemplified below, at least partially changing of a screen (e.g., the screen 120) displayed while the display operates in the state for lower power consumption. For example, the electronic device 200 may maintain an inactive state of the first processing circuitry by executing, by using the at least one third processing circuitry, at least partially changing of the screen.

FIG. 2 is a simplified block diagram of an electronic device according to an embodiment of the disclosure.

Referring to FIG. 2, an electronic device 200 may be one of various types of electronic devices such as a notebook 290, smartphones 291 having various form factors (e.g., a bar-type smartphone 291-1, a foldable-type smartphone 291-2, a multi-foldable-type smartphone 291-3, or a slidable (or rollable) type smartphone 291-4), a tablet 292, a wearable device 293 (e.g., a smart watch 293), a cellular phone, and other similar computing devices. Components illustrated in FIG. 2, their relationships, and their functions are merely exemplary and do not limit implementations described or claimed in this document. The electronic device 200 may be referred to as a user device, a multifunctional device, a mobile device, or a portable device.

The electronic device 200 may include components including one or more processors 201, volatile memory 221, a display 231, and a sensor 243. The components are merely exemplary. For example, the electronic device 200 may further include other components. For example, some components may be omitted or excluded from the electronic device 200.

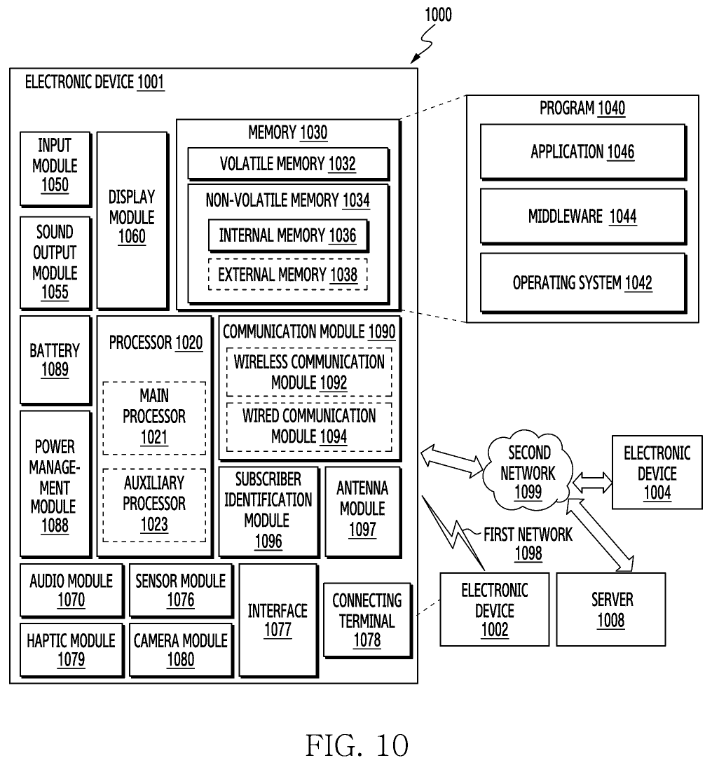

The one or more processors 201 may include at least a portion of a processor 1020 of FIG. 10 or correspond to at least a portion of the processor 1020 of FIG. 10. For example, the one or more processors 201 may be implemented as a single chip (or single chipset) such as a system on chip (SoC). For example, the one or more processors 201 may also be implemented as multiple chips (or multiple chipsets). For example, the one or more processors 201 may sometimes be referred to as a main processor (e.g., a main processor 1021 of FIG. 10) or an application processor (AP). For example, a portion of the one or more processors 201 may be referred to as a main processor or an AP, and another portion (or a remaining portion) of the one or more processors 201 may be referred to as an auxiliary processor (e.g., an auxiliary processor 1023 of FIG. 10).

The one or more processors 201 may be used to at least partially change a screen (e.g., the screen 120) displayed on the display 231 operating as the first state. The one or more processors 201 may be used to at least partially change a screen displayed on the display 231 operating as a second state (e.g., a state for performance) distinct from the first state.

The volatile memory 221 may include at least a portion of volatile memory 1032 of FIG. 10 or correspond to at least a portion of the volatile memory 1032 of FIG. 10. The volatile memory 221 may be used to at least temporarily store information (and/or data) such as an image and/or a visual object. For example, the volatile memory 221 may include a dynamic random access memory (DRAM) and/or a last level cache (LLC) memory.

The display 231 may include at least a portion of a display module 1060 of FIG. 10 or correspond to at least a portion of the display module 1060 of FIG. 10.

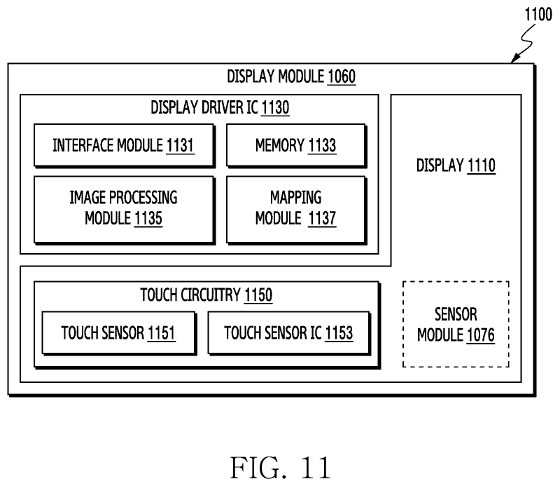

The display 231 may be used to display a screen. For example, the display 231 may include display driver circuitry 232 (e.g., the DDI 1130 of FIG. 11) and a display panel 233 (e.g., the display 1110 of FIG. 11). For example, the display driver circuitry 232 may control the display panel 233 to display a screen. For example, the screen may be displayed on the display panel 233 by the display driver circuitry 232. In this document, displaying a screen on the display 231 may indicate displaying a screen on the display panel 233.

As a non-limiting example, the display driver circuitry 232 may include internal memory (not illustrated in FIG. 2) such as a graphic random access memory (GRAM). For example, the internal memory may be used for a command mode of a display serial interface (DSI). For example, the internal memory may be used for a video mode (e.g., a first video mode to be exemplified below) of the DSI. As a non-limiting example, the electronic device 200 may support the command mode, a first video mode provided by using the internal memory, and/or a second video mode provided without using the internal memory. For example, when the electronic device 200 supports all of the command mode, the first video mode, and the second video mode, switching from the command mode to the first video mode, switching from the command mode to the second video mode, and switching from the first video mode to the second video mode may be supported by the electronic device 200.

The display 231 may operate as the first state. For example, the display 231 may operate as the first state for a function of an always on display (AoD). As a non-limiting example, the function of the AoD may indicate a function of displaying, on the display 231, visual information such as a background screen, a lock screen, an execution screen, time information, notification information, and/or guidance information during at least a portion of a time interval in which an interrupt (e.g., a user input) for changing at least a portion of a state of one or more software applications being executed in the electronic device 200 is not caused (or is ceased). As a non-limiting example, the function of the AoD may indicate a function of displaying the visual information on the display 231 during at least a portion of a time interval in which at least a portion of a state of a service provided by the electronic device 200 is not changed (or is maintained). As a non-limiting example, the function of the AoD may be executed or activated in response to a timeout of displaying a screen (e.g., displaying a lock screen). As a non-limiting example, the function of the AoD may be executed or activated in response to a predetermined user input (e.g., a user input to a physical button exposed through a portion of a housing of the electronic device 200).

The display 231 may operate as the second state. For example, the display 231 may operate as the second state during a time interval in which an interrupt (e.g., a user input) for changing at least a portion of a state of one or more software applications being executed in the electronic device 200 is caused. For example, the display 231 may operate as the second state during a time interval in which a state of a service provided by an execution screen from one or more software applications is changed.

The sensor 243 may include at least a portion of a sensor module 1076 of FIG. 10 or correspond to at least a portion of the sensor module 1076 of FIG. 10. The sensor 243 may be used to obtain sensing data indicating a state of the electronic device 200 and/or a state around the electronic device 200. As a non-limiting example, the sensing data may cause at least partially changing of a screen (or a state of the screen) displayed on the display 231 operating as the first state.

As a non-limiting example, the electronic device 200 may further include other memory distinguished from the volatile memory 221. For example, the other memory may include one or more storage media (or one or more storage devices). For example, the other memory may store instructions. The instructions may be executed individually or collectively by the one or more processors 201. For example, the instructions may be executed by first processing circuitry 211. For example, the instructions, when executed by one or more processors 201 (e.g., the first processing circuitry 211), may cause electronic device 200 to perform operations to be exemplified below.

For example, the one or more processors 201 may include first processing circuitry 211, second processing circuitry 212, and at least one third processing circuit 213.

For example, the first processing circuitry 211, the second processing circuitry 212, and the at least one third processing circuitry 213 may be included in a single chip or a single chipset.

For example, the first processing circuitry 211, the second processing circuitry 212, and the at least one third processing circuitry 213 may be included in multiple chips. As a non-limiting example, the first processing circuitry 211 and the second processing circuitry 212 may be included in a first chip, and the at least one third processing circuitry 213 may be included in a second chip separated from the first chip.

As a non-limiting example, the first processing circuitry 211 may be a central processing unit (CPU), the second processing circuitry 212 may be a display processing unit (DPU) (or a display controller), and the at least one third processing circuitry 213 may include a micro processing unit (MPU) and/or a sensor interface (or a sensor hub). As a non-limiting example, the first processing circuitry 211 may be a big core (or a performance core) of the CPU, and the at least one third processing circuitry 213 may be a little core (or an efficiency core) of the CPU.

For example, the first processing circuitry 211 may be in an inactive state for lower power consumption. For example, the first processing circuitry 211 may be in the inactive state during at least a portion of a time interval in which the display 231 operates as the first state.

For example, the inactive state of the first processing circuitry 211 may include a halt state (e.g., a C1 mode) of stopping (or turning off) main internal clocks of a CPU through software and keeping a bus interface unit (e.g., a path connecting the first processing circuitry 211 and other components (e.g., the second processing circuitry 212, the at least one third processing circuitry 213, and/or the display 231) and an interrupt controller (e.g., a programmable interrupt controller (PIC)) running at full speed, an enhanced halt state (e.g., a CIE mode) of stopping the main internal clocks through software, reducing a voltage provided to the CPU, and keeping the bus interface unit and the interrupt controller running at full speed, a state (e.g., a CIE mode) of stopping all internal clocks of the CPU, a stop grant state (e.g., a C2 mode) of stopping the main internal clocks through hardware and keeping the bus interface unit and the interrupt controller running at full speed, a stop clock state (e.g., a C2 mode) of stopping internal and external clocks of the CPU through hardware, an extended stop grant state (e.g., a C2E mode) of stopping the main internal clocks through hardware, reducing a voltage of the CPU, and keeping the bus interface unit and the interrupt controller running at full speed, a sleep state (e.g., a C3 mode) of stopping all internal clocks of the CPU, a deep sleep state (e.g., a C3 mode) of stopping all internal and external clocks of the CPU, a state (e.g., a C3 mode) of stopping all internal clocks of the CPU and reducing a voltage of the CPU, a deeper sleep state (e.g., a C4 mode) of reducing a voltage of the CPU, an enhanced deeper sleep state (e.g., a C4E mode or a C5 mode) of even more reducing a voltage of the CPU and turning off a memory cache, and/or a deep power down state (e.g., a C6 mode) of reducing an internal voltage of the CPU to a value including 0 volts (V).

For example, the inactive state of the first processing circuitry 211 may sometimes be referred to as a sleep state, a hibernate state, a soft off state, or a mechanical off state.

For example, the first processing circuitry 211 may be in an active state for performance. For example, the first processing circuitry 211 may be in the active state during a time interval in which the display 231 operates as the second state. As a non-limiting example, the first processing circuitry 211 may be in the active state during at least another portion of a time interval in which the display 231 operates as the first state.

For example, the active state of the first processing circuitry 211 may include an operating state in which the CPU is fully turned on. For example, the active state of the first processing circuitry 211 may sometimes be referred to as a working state.

For example, the second processing circuitry 212 may be used to display a screen on the display 231. For example, the second processing circuitry 212 may be used to process at least one image obtained from the first processing circuitry 211 for displaying of the screen and transmit, to the display 231, the processed at least one image. For example, the second processing circuitry 212 may be used to process at least one image obtained from the volatile memory 221 for displaying of the screen and transmit, to the display 231, the processed at least one image. As a non-limiting example, the processing may include performing a combination of images, performing a merge of images, applying a blur effect to an image, performing a crop of an image, upscaling an image, and/or downscaling an image. For example, the second processing circuitry 212 may operate in accordance with controlling of the first processing circuitry 211. For example, the second processing circuitry 212 may operate in accordance with controlling of the at least one third processing circuitry 213.

For example, the at least one third processing circuitry 213 may be used to control the display 231 during at least a portion of a time interval in which the first processing circuitry 211 is in the inactive state. For example, the at least one third processing circuitry 213 may be used to control the display 231 operating as the first state, based on the inactive state of the first processing circuitry 211. As a non-limiting example, at least a portion of the at least one third processing circuitry 213 may be activated based on a changing (or switching) of the first processing circuitry 211 from the active state of the first processing circuitry 211 to the inactive state of the first processing circuitry 211. As a non-limiting example, at least a portion of the at least one third processing circuitry 213 may be deactivated based on a changing of the first processing circuitry 211 from the active state of the first processing circuitry 211 to the inactive state of the first processing circuitry 211. As a non-limiting example, at least a portion of the at least one third processing circuitry 213 may be processing circuitry dedicated, designated, or specified to control the display 231 operating as the first state.

For example, the at least one third processing circuitry 213 may be configured to process data regarding a state of the electronic device 200 and/or a state around the electronic device 200, obtained through the sensor 243, in a format suitable for the first processing circuitry 211 and/or the second processing circuitry 212. For example, the at least one third processing circuitry 213 may obtain sensing data by using the sensor 243.

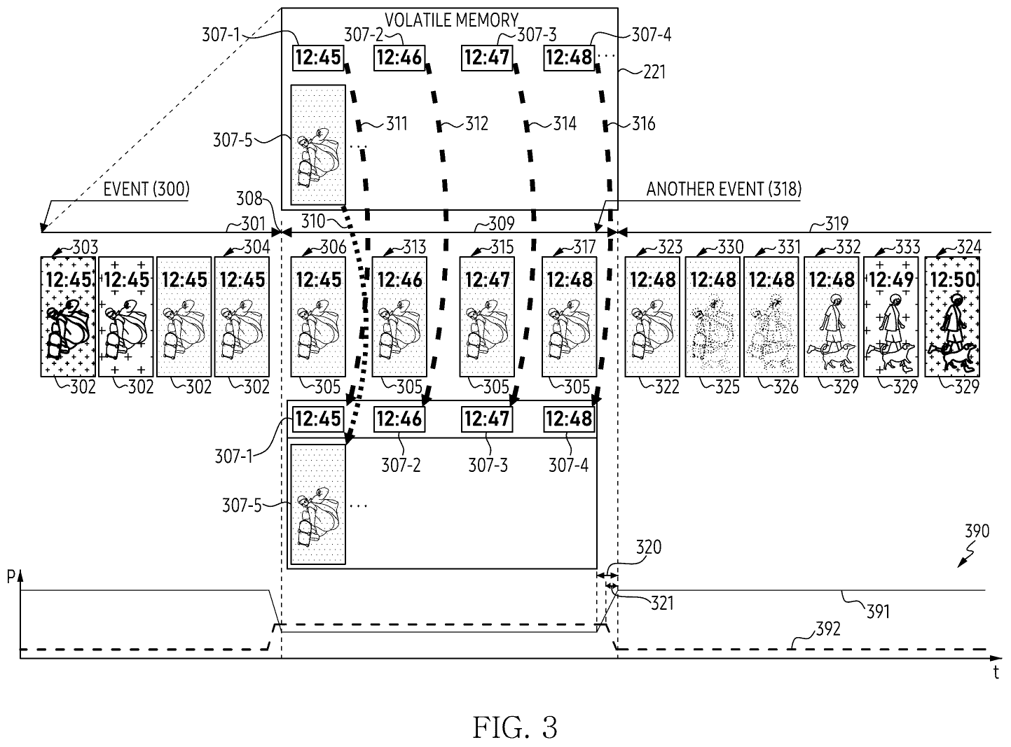

The components of the electronic device 200 exemplified through FIG. 2 may be used to execute the operations exemplified in the description of FIGS. 3 to 9.

FIG. 3 illustrates a method of at least partially changing a screen displayed on a display operating as a state for lower power consumption based on storing candidate images according to an embodiment of the disclosure.

Referring to FIG. 3, the first processing circuitry 211 may detect, identify, or obtain an event 300. The event 300 may occur to start the display 231 operating as the first state. The event 300 may include enabling the display 231 to operate as the first state. The event 300 may include disabling the display 231 to operate as the second state. The event 300 may include occurrence of a timeout for displaying a screen (e.g., a lock screen) on the display 231 operating as the second state. For example, the event 300 may include activating a function of the AoD. For example, the event 300 may include receiving, detecting, sensing, identifying, verifying, or checking a user input causing the display 231 to operate as the first state.

The first processing circuitry 211 may execute an operation (e.g., an operation for activating the function of the AoD) for the display 231 operating as the first state, in response to the event 300. The operation may be executed during a time interval 301 in which the first processing circuitry 211 operates as the active state.

For example, the operation may include executing a smooth (or gradual) change (or switch) (or transition) from a screen displayed on the display 231 operating as the second state to a screen to be displayed on the display 231 operating as the first state. For example, the first processing circuitry 211 may execute a change from a screen 302 to a screen 305, in response to the event 300. As a non-limiting example, the screen 302 may correspond to a lock screen.

For example, the first processing circuitry 211 may control, in response to the event 300, the second processing circuitry 212 to gradually decrease a brightness level of the screen 302, such as a change from a state 303 to a state 304. For example, reducing the brightness level may be executed for the display 231 operating as the first state. For example, reducing the brightness level may be executed for the smooth change.

For example, the first processing circuitry 211 may obtain an image corresponding to a screen lastly displayed on the display 231 while operating as the active state, for a screen to be initially displayed on the display 231 after the first processing circuitry 211 is switched to the inactive state. For example, the first processing circuitry 211 may control the second processing circuitry 212 to display a screen corresponding to the image on the display 231. For example, the screen 302 in the state 304 may correspond to a screen 305 in a state 306. For example, the screen 302 in the state 304 may be substantially identical to the screen 305 in the state 306. For example, the screen 302 in the state 304 and the screen 305 in the state 306 may be viewable (by a user) as the same screen. As a non-limiting example, the screen 302 in the state 304 may be classified as a screen initially displayed on the display 231 operating as the first state.

FIG. 3 illustrates an example in which a background (or a background image) of the screen 302 and a background of the screen 305 displayed on the display 231 operating as the first state are identical to each other, but this is merely exemplary. For example, when a first screen displayed on the display 231 operating as the second state before (or immediately before) the event 300 is different from a second screen to be initially displayed on the display 231 operating as the first state, the first processing circuitry 211 may obtain or render an image corresponding to at least one third screen between the first screen and the second screen for a smooth change from the first screen to the second screen. For example, the first processing circuitry 211 may control the second processing circuitry 212 to display the at least one third screen on the display 231 based on the image.

For example, the operation may include storing, in the volatile memory 221, candidate images for at least partially changing of a screen to be displayed on the display 231 operating as the first state. As exemplified in the description of FIG. 1, since the display 231 operating as the first state causes relatively higher power consumption, the first processing circuitry 211 may store, in the volatile memory 221, the candidate images in response to the event 300 to maintain the inactive state of the first processing circuitry 211 while the display 231 operates as the first state. For example, the first processing circuitry 211 may perform a batch rendering to record the candidate images in the volatile memory 221, before the first processing circuitry 211 is switched to the inactive state in response to the event 300. For example, the first processing circuitry 211 may include the candidate images that are estimated or predicted to be displayed on the display 231 operating as the first state. For example, the candidate images may include a candidate image 307-1, a candidate image 307-2, a candidate image 307-3, a candidate image 307-4, and a candidate image 307-5. For example, a portion of the candidate images stored in the volatile memory 221 may not be simultaneously displayed on the display 231 operating as the first state with another portion of the candidate images stored in the volatile memory 221. For example, since the candidate images 307-1, 307-2, 307-3, and 307-4 indicate different times, the candidate images 307-1, 307-2, 307-3, and 307-4 may not be displayed simultaneously. For example, at least a portion of the candidate images may be obtained based on a state of the electronic device 200 and/or a state around the electronic device 200 (including a state of a user) recognized before the event 300. For example, at least a portion of the candidate images may be obtained based on a state of the electronic device 200 and/or a state around the electronic device 200 recognized during at least a portion of the time interval 301. For example, at least a portion of the candidate images may be obtained based on an execution state of one or more software applications and/or a state of a service provided by the electronic device 200. For example, a portion of the candidate images may be preset. For example, a background of a screen to be displayed on the display 231 operating as the first state may be preset regardless of a state of the electronic device 200 and a state around the electronic device 200. For example, the portion of the candidate images used as the background may be preset. For example, the candidate images may include a candidate image 307-5 corresponding to a background of a screen to be displayed on the display 231 operating as the first state. For example, the candidate image 307-5 may at least partially correspond to the screen 302 in the state 304.

For example, the operation may include executing a handover to the at least one third processing circuitry 213 for the display 231. For example, the first processing circuitry 211 may activate the at least a portion of the at least one third processing circuitry 213, in response to the event 300. For example, a chart 390 having a horizontal axis indicating time and a vertical axis indicating power may include a line 392 indicating power consumed by the at least one third processing circuitry 213 over time. As indicated by the line 392 within the time interval 301, the at least one third processing circuitry 213 may be changed to the active state. As a non-limiting example, the first processing circuitry 211 may include providing, to the at least one third processing circuitry 213, commands for the display 231 to be used during a time interval 309 in response to the event 300.

For example, a state of the first processing circuitry 211 may be changed or switched to the inactive state after the operation is executed. For example, at a timing 308, the change of the first processing circuitry 211 to the inactive state may be completed. For example, the chart 390 may include a line 391 indicating power consumed by the first processing circuitry 211 over time. For example, as indicated by the line 391 within the time interval 301, the active state of the first processing circuitry 211 may be changed to the inactive state of the first processing circuitry 211.

The at least one third processing circuitry 213 may execute an operation for controlling the display 231 operating as the first state, while the first processing circuitry 211 is in the inactive state, as indicated by the line 391 within the time interval 309. For example, the operation may be executed during the time interval 309.

For example, the operation may include controlling or causing the second processing circuitry 212 to display a screen on the display 231 operating as the first state while the first processing circuitry 211 is in the inactive state. For example, as indicated by an arrow 310, the at least one third processing circuitry 213 may control the second processing circuitry 212 to obtain, from the volatile memory 221, a candidate image 307-5 from among the candidate images. For example, as indicated by an arrow 311, the at least one third processing circuitry 213 may control the second processing circuitry 212 to obtain, from the volatile memory 221, a candidate image 307-1 from among the candidate images. For example, the at least one third processing circuitry 213 may control the second processing circuitry 212 to obtain an image by adding the candidate image 307-1 into the candidate image 307-5. For example, the at least one third processing circuitry 213 may control the second processing circuitry 212 to transmit, to the display 231, data on the image to display a screen 305 in a state 306 on the display 231 operating as the first state. For example, the data on the image may be used by the display driver circuitry 232 to display the screen 305 in the state 306. For example, the data on the image may be referred to as data associated with the candidate image 307-1 used to obtain the image or data associated with the candidate image 307-5 used to obtain the image. As a non-limiting example, the display driver circuitry 232 may include memory (e.g., the memory 1133 of FIG. 11). For example, the at least one third processing circuitry 213 may cause or control the second processing circuitry 212 to store, in the memory within the display driver circuitry 232, the data on the image. For example, the second processing circuitry 212 may transmit, to the display driver circuitry 232, the data regarding the image through an interface (e.g., a mobile industry processor interface (MIPI), a display port (DP), or an embedded display port (eDP)) between the second processing circuitry 212 and the display driver circuitry 232. For example, the second processing circuitry 212 may transmit the data based on a command mode of a MIPI display serial interface (DSI). For example, the second processing circuitry 212 may transmit the data based on a video mode (or a hybrid video mode) of the MIPI DSI. The display driver circuitry 232 may store at least a portion of the data in the memory within the display driver circuitry 232 and display a screen 305 by scanning the at least a portion of the data from the memory. For example, the display driver circuitry 232 may, based on the command mode of the MIPI DSI, store the at least a portion of the data and scan the at least a portion of the data. For example, based on the video mode (or the hybrid video mode) of the MIPI DSI, it may store the at least a portion of the data and scan the at least a portion of the data. It should be noted that the operations of the display driver circuitry 232 exemplified below may be executed using the memory within the display driver circuitry 232.

For example, the operation may include controlling or causing the second processing circuitry 212 to at least partially change a screen displayed on the display 231 operating as the first state while the first processing circuitry 211 is in the inactive state.

For example, as indicated by an arrow 312, the at least one third processing circuitry 213 may control the second processing circuitry 212 to further obtain, from the volatile memory 221, a candidate image 307-2 from among the candidate images to reflect a change of time information in the screen 305. For example, the at least one third processing circuitry 213 may control the second processing circuitry 212 to obtain an image by adding the candidate image 307-2 into the candidate image 307-5. For example, the at least one third processing circuitry 213 may control the second processing circuitry 212 to transmit, to the display 231, data regarding the obtained image to at least partially change the screen 305 displayed on the display 231 operating as the first state. For example, the data regarding the image may be referred to as data associated with the candidate image 307-2 used to obtain the image or data associated with the candidate image 307-5 used to obtain the image. For example, the state 306 may be changed to a state 313 according to the transmission of the data regarding the image.

For example, as indicated by an arrow 314, the at least one third processing circuitry 213 may control the second processing circuitry 212 to further obtain, from the volatile memory 221, a candidate image 307-3 from among the candidate images to reflect a change of time information in the screen 305. For example, the at least one third processing circuitry 213 may control the second processing circuitry 212 to obtain an image by adding the candidate image 307-3 into the candidate image 307-5. For example, the at least one third processing circuitry 213 may control the second processing circuitry 212 to transmit, to the display 231, data regarding the obtained image to at least partially change the screen 305 displayed on the display 231 operating as the first state. For example, the data regarding the image may be referred to as data associated with the candidate image 307-3 used to obtain the image or data associated with the candidate image 307-5 used to obtain the image. For example, the state 313 may be changed to a state 315 according to the transmission of the data regarding the image.

For example, as indicated by an arrow 316, the at least one third processing circuitry 213 may control the second processing circuitry 212 to further obtain, from the volatile memory 221, a candidate image 307-4 from among the candidate images to reflect a change of time information in the screen 305. For example, the at least one third processing circuitry 213 may control the second processing circuitry 212 to obtain an image by adding the candidate image 307-4 into the candidate image 307-5. For example, the at least one third processing circuitry 213 may control the second processing circuitry 212 to transmit, to the display 231, data regarding the obtained image to at least partially change the screen 305 displayed on the display 231 operating as the first state. For example, the data regarding the image may be referred to as data associated with the candidate image 307-4 used to obtain the image or data associated with the candidate image 307-5 used to obtain the image. For example, the state 315 may be changed to a state 317 according to the transmission of the data regarding the image.

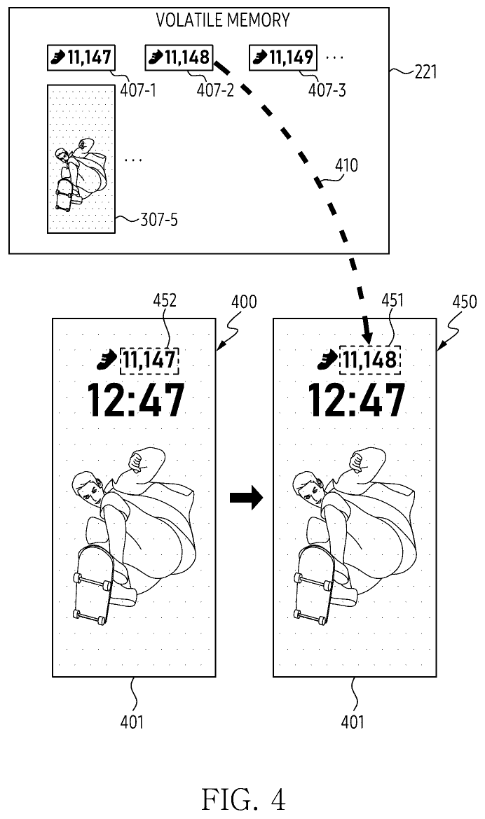

Although not illustrated in FIG. 3, for example, the operation may include controlling or causing the second processing circuitry 212 to execute at least a portion of operations to be exemplified in the description of FIGS. 4 to 9 to at least partially change a screen (or a state of the screen) displayed on the display 231 operating as the first state.

For example, the operation may include executing a handover to the first processing circuitry 211 for the display 231. For example, the at least one third processing circuitry 213 may execute the handover in response to another event 318. The other event 318 may occur to start the display 231 operating as the second state. The other event 318 may occur to cease (or terminate) the display 231 operating as the first state. The other event 318 may include activating the display 231 operating as the second state. The other event 318 may include deactivating the display 231 operating as the first state. For example, the other event 318 may include deactivating the function of the AoD. For example, the other event 318 may include executing a function (or an interrupt) that is not supported by the display 231 operating as the first state. For example, the other event 318 may include receiving, detecting, sensing, identifying, verifying, or checking a user input causing the display 231 to operate as the second state. For example, as indicated by a line 391 within a time interval 320, a change of the first processing circuitry 211 from the inactive state of the first processing circuitry 211 to the active state of the first processing circuitry 211 may be executed in response to the other event 318. As a non-limiting example, a change (or switch) to the active state of the first processing circuitry 211 may be triggered by the at least one third processing circuitry 213. As a non-limiting example, the candidate images (e.g., the candidate images 307-1, 307-2, 307-3, 307-4, and 307-5) stored in the volatile memory 221 may be flushed based on the activation of the first processing circuitry 211. As a non-limiting example, as indicated by a line 392 within a time interval 321, deactivating the at least a portion of the at least one third processing circuitry 213 may be executed in response to the other event 318.

For example, the first processing circuitry 211 may execute an operation for the display 213 operating as the second state, in response to the other event 318. The operation may be executed during a time interval 319 in which the first processing circuitry 211 operates as the active state, as indicated by the line 391. The operation may be executed while at least a portion of the at least one third processing circuitry 213 is deactivated, as indicated by the line 392.

For example, the operation may include executing a smooth (or gradual) change (or switch) (or transition) from a screen displayed on the display 231 operating as the first state to a screen to be displayed on the display 231 operating as the second state. For example, the first processing circuitry 211 may execute a change from the screen 305 to a screen 322, in response to the other event 318.

For example, the first processing circuitry 211 may control the second processing circuitry 212 to (gradually) increase a brightness level provided by the display 231, such as a change from a state 323 to a state 324, in response to the other event 318. For example, increasing the brightness level may be executed for the display 231 operating as the second state. For example, increasing the brightness level may be executed for the smooth change.

For example, the first processing circuitry 211 may obtain or render an image corresponding to a screen lastly displayed on the display 231 while operating as the inactive state, for a screen initially displayed on the display 231 after the first processing circuitry 211 is switched to the active state. For example, the first processing circuitry 211 may control the second processing circuitry 212 to display a screen based on the image. For example, the screen 322 in the state 323 may correspond to the screen 305 in the state 317. For example, the screen 322 in the state 323 may be substantially identical to the screen 305 in the state 317. For example, the screen 322 in the state 323 and the screen 305 in the state 317 may be viewable (by a user) as the same screen. As a non-limiting example, the screen 322 in the state 323 may be classified as a screen lastly displayed on the display 231 operating as the first state.

For example, when a screen 329 to be displayed according to the other event 318 is at least partially different from the screen 305 (or the screen 322) that was displayed on the display 231 operating as the first state, the first processing circuitry 211 may obtain or render at least one image corresponding to at least one screen between the screen 305 and the screen 329 for a smooth change from the screen 305 to the screen 329. For example, the first processing circuitry 211 may control the second processing circuitry 212 to display the at least one screen on the display 231, based on the at least one image.

For example, the first processing circuitry 211 may obtain an image corresponding to a screen 325 by executing a first interpolation using a first image corresponding to the screen 305 (or the screen 322) and a second image corresponding to the screen 329. For example, the first interpolation may be executed by applying a first weight to the first image and applying a second weight, lower than the first weight, to the second image. For example, the first processing circuitry 211 may control the second processing circuitry 212 to display the screen 325 based on the image, as in a state 330.

For example, the first processing circuitry 211 may obtain an image corresponding to a screen 326 by executing a second interpolation using the first image and the second image. For example, the second interpolation may be executed by applying a first weight to the first image and applying a third weight, lower than the first weight and higher than the second weight, to the second image. For example, the first processing circuitry 211 may control the second processing circuitry 212 to display the screen 326 based on the image, as in a state 331.

For example, the first processing circuitry 211 may control the second processing circuitry 212 to display the screen 329 on the display 231, as in a state 332. For example, since the state 332 is changed from the state 323 through the states 330 and 331, the electronic device 200 may provide the smooth change.

For example, the first processing circuitry 211 may control the second processing circuitry 212 to increase a brightness level of the screen 329 as in a state 333 changed from the state 332 and increase the brightness level of the screen 329 as in the state 324 changed from the state 333.

FIG. 3 illustrates storing, in the volatile memory 221, candidate images (e.g., candidate images 307-1, 307-2, 307-3, and 307-4) for time information in response to the event 300, but this is merely exemplary. The first processing circuitry 211 may obtain candidate images associated with obtaining sensing data from the sensor 243 in response to the event 300 and may store the obtained candidate images in the volatile memory 221. For example, at least one software application of the electronic device 200 that provides a service by using the sensor 243 may be set or configured to maintain execution while the display 231 operates as the first state. For example, the first processing circuitry 211 may obtain or identify, from the at least one software application, at least one candidate image associated with sensing data to be obtained through the sensor 243 while the display 231 operates as the first state, in response to the event 300. For example, the first processing circuitry 211 may store, in the volatile memory 221, the at least one candidate image. An example of the at least one candidate image is exemplified in the description of FIG. 4.

FIG. 4 illustrates a method of at least partially changing a screen displayed on a display operating as a state for lower power consumption based on sensing data according to an embodiment of the disclosure.

Referring to FIG. 4, the first processing circuitry 211 may store, in the volatile memory 221, the candidate images, in response to the event 300. For example, the candidate images stored in the volatile memory 221 may include a candidate image 307-5 used as a background, a candidate image 407-1 associated with sensing data, a candidate image 407-2 associated with sensing data, and a candidate image 407-3 associated with sensing data. For example, the first processing circuitry 211 may be switched to the inactive state for the display 231 operating as the first state, after storing the candidate images.

For example, the at least one third processing circuitry 213 may obtain sensing data through the sensor 243 while the inactive state of the first processing circuitry 211 is maintained. For example, the sensing data may be obtained by the sensor interface or the sensor hub. For example, as in a state 400, the sensing data may be obtained while a screen 401 is displayed on the display 231 operating as the first state.

For example, the at least one third processing circuitry 213 may control the second processing circuitry 212 to obtain, from the volatile memory 221, a candidate image 407-2 corresponding to the sensing data, while the inactive state of the first processing circuitry 211 is maintained. For example, the at least one third processing circuitry 213 may control the second processing circuitry 212 to transmit, to the display 231, data associated with the candidate image 407-2 to at least partially change a screen 401 being displayed on the display 231 operating as the first state based on the candidate image 407-2. For example, the data associated with the candidate image 407-2 may be obtained by adding the candidate image 407-2 to a candidate image 307-5 used as a background of the screen 401. For example, the at least one third processing circuitry 213 may obtain an image by adding the candidate image 407-2 to the candidate image 307-5. For example, the data associated with the candidate image 407-2 may include data regarding the image. For example, the data associated with the candidate image 407-2 transmitted to the display 231 may cause displaying the screen 401 on the display 231 operating as the first state, as in a state 450. For example, the data associated with the candidate image 407-2 transmitted to the display 231 may cause a change from the state 400 to the state 450. For example, as in the state 450, the screen 401 may include a visual object 451 changed from a visual object 452. The visual object 451 may correspond to the candidate image 407-2, as indicated by an arrow 410.

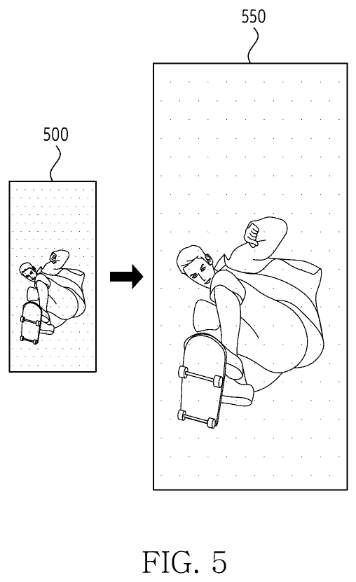

For example, the at least one third processing circuitry 213 may control the second processing circuitry 212 to upscale or downscale a candidate image obtained from the volatile memory 221 while the first processing circuitry 211 is in the inactive state. For example, the at least one third processing circuitry 213 may control the second processing circuitry 212 to transmit, to the display 231, data associated with the upscaled or downscaled candidate image (or data regarding the upscaled or scaled-down candidate image). For example, the data associated with the candidate image may be used to display a screen including at least a portion corresponding to the candidate image on the display 231 operating as the first state. For example, the data associated with the candidate image may be used to at least partially change the screen displayed on the display 231 operating as the first state. Upscaling the candidate image may be exemplified in the description of FIG. 5.

FIG. 5 illustrates a method of upscaling an image to be displayed on a display operating as a state for lower power consumption according to an embodiment of the disclosure.

Referring to FIG. 5, in the active state, the first processing circuitry 211 may store, in the volatile memory 221, a candidate image for displaying on the display 231 operating as the first state (or a candidate image for at least partially changing a screen to be displayed on the display 231 operating as the first state). For a storage space of the volatile memory 221, a size (or resolution) of the candidate image may be smaller than a size (or resolution) of an image used to display or change at least a portion of the screen.

For example, the first processing circuitry 211 may store a candidate image 500 in the volatile memory 221. For example, the first processing circuitry 211 may switch to the inactive state after storing the candidate image 500.

For example, the at least one third processing circuitry 213 may control the second processing circuitry 212 to obtain the candidate image 500 from the volatile memory 221, while the inactive state of the first processing circuitry 211 is maintained. For example, the at least one third processing circuitry 213 may control the second processing circuitry 212 to obtain an image 550 by upscaling the candidate image 500 while the inactive state of the first processing circuitry 211 is maintained. For example, the at least one third processing circuitry 213 may transmit data regarding the image 550 (or data associated with the image 550) to the display 231 operating as the first state. The data may be transmitted to the display 231 to at least partially change a screen displayed on the display 231 operating as the first state or display a screen on the display 231 operating as the first state.

Unlike FIG. 5, the first processing circuitry 211 may store, in the volatile memory 221, a candidate image having a size (or resolution) larger than a size (or resolution) of an image used to display a screen on the display 231 operating as the first state. For example, the first processing circuitry 211 may switch to the inactive state after storing the candidate image.

For example, the at least one third processing circuitry 213 may control the second processing circuitry 212 to obtain the candidate image from the volatile memory 221 while the inactive state of the first processing circuitry 211 is maintained. For example, the at least one third processing circuitry 213 may control the second processing circuitry 212 to obtain an image by downscaling the obtained candidate image while the inactive state of the first processing circuitry 211 is maintained. For example, the at least one third processing circuitry 213 may transmit data regarding the image (or data associated with the image) to the display 231 operating as the first state. The data may be transmitted to the display 231 to at least partially change a screen displayed on the display 231 operating as the first state or display a screen on the display 231 operating as the first state.

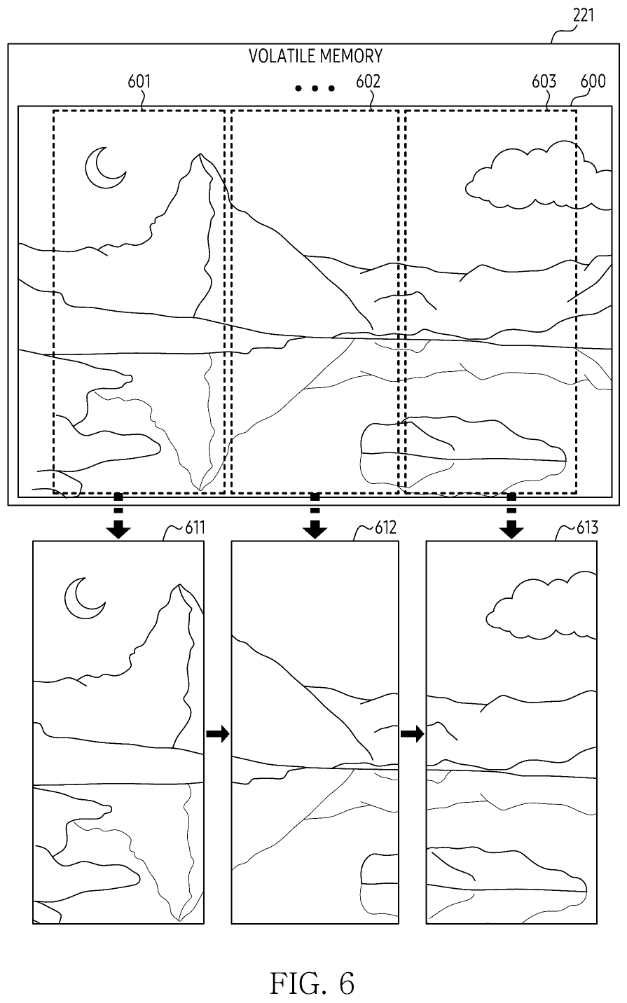

For example, the at least one third processing circuitry 213 may control the second processing circuitry 212 to obtain a portion of a candidate image from the volatile memory 221, while the first processing circuitry 211 is in the inactive state. For example, a size of the candidate image may be larger than a size of an image used to display a screen on the display 231 operating as the first state. Since the size of the candidate image is larger than the size of the image, the at least one third processing circuitry 213 may control the second processing circuitry 212 to obtain the portion of the candidate image from the volatile memory 221. For example, the at least one third processing circuitry 213 may control the second processing circuitry 212 to obtain periodically a portion of the candidate image while the inactive state of the first processing circuitry 211 is maintained. The periodically obtaining of the portion of the candidate image is exemplified in the description of FIG. 6.

FIG. 6 illustrates a method of displaying a screen having a background partially changed in accordance with a cycle on a display operating as a state for lower power consumption by using address information changed in accordance with the cycle according to an embodiment of the disclosure.

Referring to FIG. 6, the first processing circuitry 211 may, while operating as the active state, store, in the volatile memory 221, a candidate image 600 for displaying on the display 231 operating as a first state (or a candidate image 600 for at least partially changing a screen to be displayed on the display 231 operating as the first state). For example, a size of the candidate image 600 may be larger than a size of an image for a screen to be displayed on the display 231 operating as the first state. For example, the first processing circuitry 211 may enter the inactive state after storing the candidate image 600.

The at least one third processing circuitry 213 may control the second processing circuitry 212 to obtain a portion of the candidate image 600 as the image for a screen to be displayed on the display 231 operating as the first state, while the inactive state of the first processing circuitry 211 is maintained. For example, the at least one third processing circuitry 213 may control the second processing circuitry 212 to change, based on a cycle (e.g., a predetermined cycle or a reference cycle), a portion of the candidate image 600 obtained from the volatile memory 221 by accessing the volatile memory 221 using address information (e.g., a start address for reading the candidate image 600 from the volatile memory 221) changed according to the cycle, in order to display a screen having a background partially changed according to the cycle on the display 231 operating as the first state. For example, that a background is partially changed may indicate that a portion of the background is maintained on the display 231 operating as the first state and another portion of the background is changed on the display 231 operating as the first state.

For example, a background provided on the display 231 through the image may indirectly indicate time (or local time). For example, the at least one third processing circuitry 213 may control the second processing circuitry 212 to obtain, from the volatile memory 221, a portion (not illustrated in FIG. 6) of the candidate image 600 including the sun (not illustrated in the candidate image 600) by accessing the volatile memory 221 using address information, in order to display, on the display 231 operating as the first state, a screen including a background including the sun (not illustrated in FIG. 6) within a first time from sunrise to sunset. For example, the at least one third processing circuitry 213 may control the second processing circuitry 212 to obtain, from the volatile memory 221, another portion (e.g., a portion 611 of the candidate image 600) of the candidate image 600 including the moon, by accessing the volatile memory 221 using other address information (e.g., address information partially different from the address information for obtaining the portion of the candidate image 600), in order to display, on the display 231 operating as the first state, a screen including a background including the moon within a second time from sunset to sunrise.

For example, a background provided on the display 231 through the image may indirectly indicate weather. For example, the at least one third processing circuitry 213 may control the second processing circuitry 212 to obtain, from the volatile memory 221, a portion (e.g., the portion 611 of the candidate image 600) of the candidate image 600 including the moon by accessing the volatile memory 221 using address information, in order to display, on the display 231 operating as the first state, a screen including a background representing clear weather. For example, the at least one third processing circuitry 213 may control the second processing circuitry 212 to obtain, from the volatile memory 221, another portion (e.g., a portion 613 of the candidate image 600) of the candidate image 600 including clouds by accessing the volatile memory 221 using other address information (e.g., address information partially different from the address information for obtaining the portion of the candidate image 600), in order to display, on the display 231 operating as the first state, a screen including a background representing cloudy weather.

For example, the at least one third processing circuitry 213 may control the second processing circuitry 212 to transmit, to the display 231 operating as the first state, data associated with the portion of the candidate image 600 based on the cycle. For example, the data associated with the portion of the candidate image 600 transmitted to the display 231 based on the cycle may be used to display, on the display 231 operating as the first state, a screen having a background partially changed according to the cycle.

For example, the at least one third processing circuitry 213 may control the second processing circuitry 212 to obtain a portion 611 of the candidate image 600 by accessing the volatile memory 221 using address information indicating an area 601 of the volatile memory 221 at a first timing, while the inactive state of the first processing circuitry 211 is maintained. For example, the at least one third processing circuitry 213 may control the second processing circuitry 212 to transmit, to the display 231, data regarding the portion 611 of the candidate image 600, in order to display, on the display 231 operating as the first state, a first screen corresponding to the portion 611 of the candidate image 600.

For example, the at least one third processing circuitry 213 may control the second processing circuitry 212 to obtain a portion 612 of the candidate image 600 by accessing the volatile memory 221 using address information indicating an area 602 of the volatile memory 221 at a second timing after a reference time (e.g., corresponding to the cycle) from the first timing, while the inactive state of the first processing circuitry 211 is maintained. For example, the at least one third processing circuitry 213 may control the second processing circuitry 212 to transmit, to the display 231, data regarding the portion 612 of the candidate image 600, in order to display, on the display 231 operating as the first state, a second screen corresponding to the portion 612 of the candidate image 600. For example, the first screen may be changed to the second screen, based on the transmission of the data regarding the portion 612 of the candidate image 600.

For example, the at least one third processing circuitry 213 may control the second processing circuitry 212 to obtain a portion 613 of the candidate image 600 by accessing the volatile memory 221 using address information indicating an area 603 of the volatile memory 221 at a third timing after the reference time (e.g., corresponding to the cycle) from the second timing, while the inactive state of the first processing circuitry 211 is maintained. For example, the at least one third processing circuitry 213 may control the second processing circuitry 212 to transmit, to the display 231, data regarding the portion 613 of the candidate image 600, in order to display, on the display 231 operating as the first state, a third screen corresponding to the portion 613 of the candidate image 600. For example, the second screen may be changed to the third screen based on the transmission of the data regarding the portion 613 of the candidate image 600.

For example, sequentially displaying of the first screen, the second screen, and the third screen may provide an animation or a video. For example, providing the animation or the video may reduce a probability that burn-in occurs according to displaying on the display 231 operating as the first state.

As a non-limiting example, the first processing circuitry 211 may execute recognition of the candidate image 600 before storing the candidate image 600 in the volatile memory 221. For example, the first processing circuitry 211 may obtain, from the candidate image 600, at least one object as a reference object, based on the recognition. The at least one object obtained as the reference object may be used to obtain address information for a screen (e.g., the third screen changed from the first screen through the second screen) changed according to the cycle. For example, based on the recognition, the first processing circuitry 211 may obtain first address information for obtaining a portion 611 of the candidate image 600 including a first object (e.g., the moon in the candidate image 600), second address information for obtaining a portion 613 of the candidate image 600 including a second object (e.g., a cloud in the candidate image 600), and third address information for obtaining a portion 612 of the candidate image 600 used for at least one screen (e.g., the second screen) between the first screen corresponding to the portion 611 of the candidate image 600 and the third screen corresponding to the portion 613 of the candidate image 600. For example, the first processing circuitry 211 may store the candidate image 600 in the volatile memory 221, transmit the first address information, the second address information, and the third address information to the at least one third processing circuitry 213, and then change the state of the first processing circuitry 211 to the inactive state. For example, the at least one third processing circuitry 213 may, while the inactive state of the first processing circuitry 211 is maintained, control the second processing circuitry 212 to obtain the portion 611 of the candidate image 600 from the volatile memory 221 using the first address information, control the second processing circuitry 212 to obtain the portion 612 of the candidate image 600 from the volatile memory 221 using the third address information, and control the second processing circuitry 212 to obtain the portion 613 of the candidate image 600 from the volatile memory 221 using the second address information. Based on such control, according to the third screen changed from the first screen through the second screen, the first object obtained as the reference object may be moved leftward on the display 231 operating as the first state, and the second object obtained as the reference object may be moved rightward on the display 231 operating as the first state.

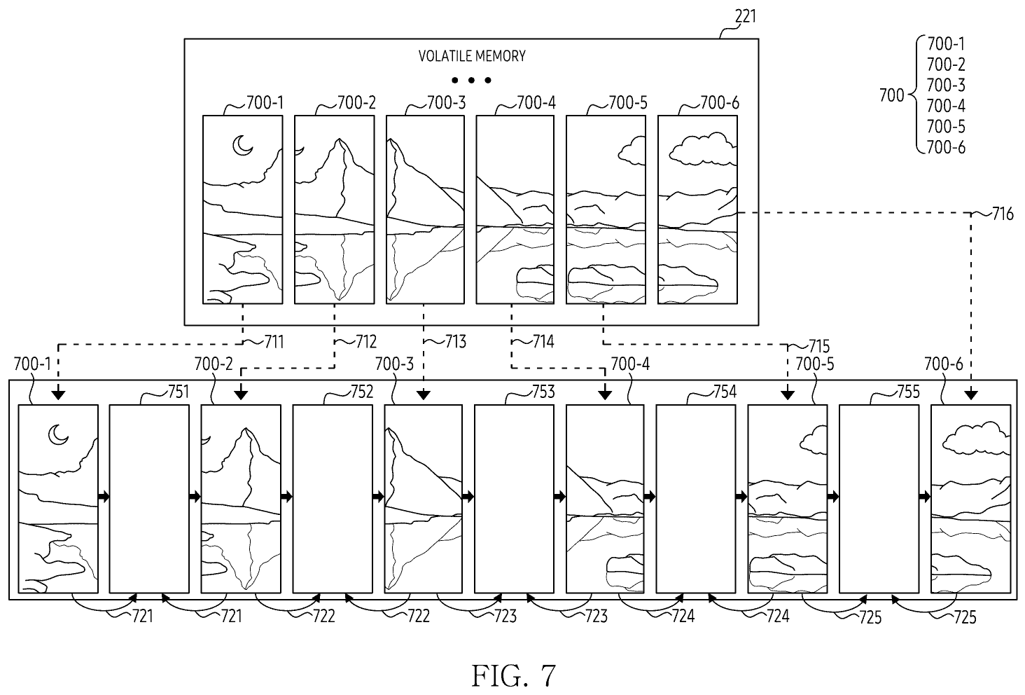

For example, the at least one third processing circuitry 213 may control the second processing circuitry 212 to execute an interpolation using candidate images obtained from the volatile memory 221, while the inactive state of the first processing circuitry 211 is maintained. The interpolation may be executed to provide an animation. For example, the interpolation may be executed to increase the number of images used to provide the animation. For example, the interpolation may be executed to provide the animation more smoothly. The interpolation is exemplified in the description of FIG. 7.

FIG. 7 illustrates a method of providing an animation through a screen displayed on a display operating as a state for lower power consumption based on executing an interpolation of images according to an embodiment of the disclosure.

Referring to FIG. 7, the first processing circuitry 211 may write candidate images 700 for displaying on the display 231 operating as the first state into the volatile memory 221, while the active state is maintained. For example, the candidate images 700 may be concatenated for an animation or associated with each other for the animation. The first processing circuitry 211 may be changed to the inactive state, in response to storing the candidate images 700.

The at least one third processing circuitry 213 may control the second processing circuitry 212 to read, from the volatile memory 221, a candidate image 700-1 and a candidate image 700-2 from among the candidate images 700, as indicated by arrows 711 and 712, while the inactive state of the first processing circuitry 211 is maintained. The at least one third processing circuitry 213 may, while the inactive state of the first processing circuitry 211 is maintained, control the second processing circuitry 212 to obtain an image 751 between the candidate image 700-1 and the candidate image 700-2 by executing an interpolation using the candidate image 700-1 and the candidate image 700-2, as indicated by an arrow 721.

The at least one third processing circuitry 213 may, while the inactive state of the first processing circuitry 211 is maintained, control the second processing circuitry 212 to read, from the volatile memory 221, a candidate image 700-3 from among the candidate images 700, as indicated by an arrow 713. The at least one third processing circuitry 213 may, while the inactive state of the first processing circuitry 211 is maintained, control the second processing circuitry 212 to obtain an image 752 between the candidate image 700-2 and the candidate image 700-3 by executing an interpolation using the candidate image 700-2 and the candidate image 700-3, as indicated by an arrow 722.

The at least one third processing circuitry 213 may, while the inactive state of the first processing circuitry 211 is maintained, control the second processing circuitry 212 to read, from the volatile memory 221, a candidate image 700-4 from among the candidate images 700, as indicated by an arrow 714. The at least one third processing circuitry 213 may, while the inactive state of the first processing circuitry 211 is maintained, control the second processing circuitry 212 to obtain an image 753 between the candidate image 700-3 and the candidate image 700-4 by executing an interpolation using the candidate image 700-3 and the candidate image 700-4, as indicated by an arrow 723.

The at least one third processing circuitry 213 may, while the inactive state of the first processing circuitry 211 is maintained, control the second processing circuitry 212 to read, from the volatile memory 221, a candidate image 700-5 from among the candidate images 700, as indicated by an arrow 715. The at least one third processing circuitry 213 may, while the inactive state of the first processing circuitry 211 is maintained, control the second processing circuitry 212 to obtain an image 754 between the candidate image 700-4 and the candidate image 700-5 by executing an interpolation using the candidate image 700-4 and the candidate image 700-5, as indicated by an arrow 724.

The at least one third processing circuitry 213 may, while the inactive state of the first processing circuitry 211 is maintained, control the second processing circuitry 212 to read, from the volatile memory 221, a candidate image 700-6 from among the candidate images 700, as indicated by an arrow 716. The at least one third processing circuitry 213 may, while the inactive state of the first processing circuitry 211 is maintained, control the second processing circuitry 212 to obtain an image 755 between the candidate image 700-5 and the candidate image 700-6 by executing an interpolation using the candidate image 700-5 and the candidate image 700-6, as indicated by an arrow 725.

The at least one third processing circuitry 213 may, while the inactive state of the first processing circuitry 211 is maintained, control the second processing circuitry 212 to sequentially transmit, to the display 231, data regarding the candidate image 700-1 (or data associated with the candidate image 700-1), data regarding the image 751 (or data associated with the image 751), data regarding the candidate image 700-2 (or data associated with the candidate image 700-2), data regarding the image 752 (or data associated with the image 752), data regarding the candidate image 700-3 (or data associated with the candidate image 700-3), data regarding the image 753 (or data associated with the image 753), data regarding the candidate image 700-4 (or data associated with the candidate image 700-4), data regarding the image 754 (or data associated with the image 754), data regarding the candidate image 700-5 (or data associated with the candidate image 700-5), data regarding the image 755 (or data associated with the image 755), and data regarding the candidate image 700-6 (or data associated with the candidate image 700-6). The sequential transmission may be executed to provide an animation through a screen displayed on the display 231 operating as the first state.

Unlike the illustration of FIG. 7, the candidate images 700-1 to 700-6 may be partial images within a single candidate image (e.g., the candidate image 600). For example, the at least one third processing circuitry 213 may, while the inactive state of the first processing circuitry 211 is maintained, control the second processing circuitry 212 to execute one or more interpolations using the partial images to provide the animation.

The animation provided through the operations exemplified in the description of FIG. 7 may reduce a probability that burn-in occurs according to displaying on the display 231 operating as the first state.

As a non-limiting example, the first processing circuitry 211 may recognize candidate images (e.g., candidate images 700-1 to 700-6) to be stored in the volatile memory 221 to obtain at least one object from a portion of the candidate images as a reference object. For example, the first processing circuitry 211 may set the number of first images to be obtained according to an interpolation executed using the portion of the candidate images including the at least one object, and the number of second images to be obtained according to an interpolation executed using another portion of the candidate images not including the at least one object, such that the at least one object is focused. For example, the number of the first images may be greater than the number of the second images to focus the at least one object. For example, the first processing circuitry 211 may store the candidate images in the volatile memory 221, transmit information on the number of the first images and the number of the second images to the at least one third processing circuitry 213, and then change the state of the first processing circuitry 211 to the inactive state. For example, the at least one third processing circuitry 213 may, while the inactive state of the first processing circuitry 211 is maintained, control the second processing circuitry 212 to execute an interpolation based on the information for an animation in which the at least one object is focused.

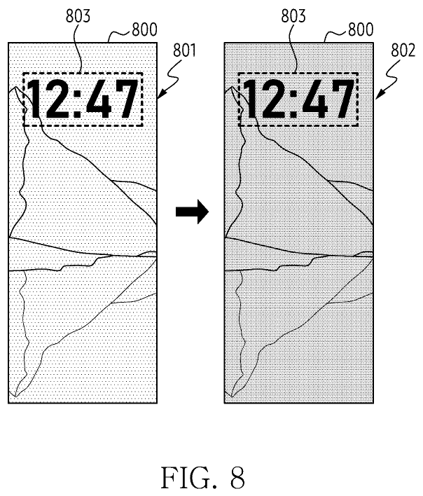

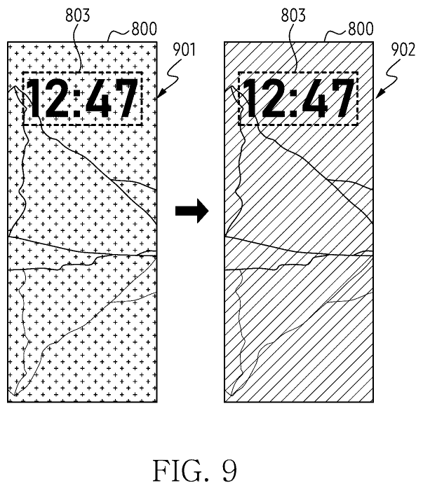

For example, the at least one third processing circuitry 213 may, while the first processing circuitry 211 is in the inactive state, control the second processing circuitry 212 to at least partially change a state of a screen displayed on the display 231 operating as the first state. The at least partially changing of the state is exemplified in the descriptions of FIGS. 8 and 9.

FIG. 8 illustrates a method of changing a brightness level of a screen displayed on a display operating as a state for lower power consumption according to an embodiment of the disclosure.

Referring to FIG. 8, the at least one third processing circuitry 213 may, while the inactive state of the first processing circuitry 211 is maintained, control the second processing circuitry 212 to change a brightness level of a screen 800 displayed on the display 231 operating as the first state.

For example, in a state 801, the at least one third processing circuitry 213 may, while the inactive state of the first processing circuitry 211 is maintained, control the second processing circuitry 212 so that the screen 800 displayed on the display 231 operating as the first state has a first brightness level. For example, the first brightness level may be set based on a command provided from the second processing circuitry 212 to the display driver circuitry 232. For example, the at least one third processing circuitry 213 may, while the inactive state of the first processing circuitry 211 is maintained, control the second processing circuitry 212 to transmit the command to the display 231 for the state 801. For example, the first brightness level may also be set by controlling the second processing circuitry 212 to change a brightness level (or grayscale value) of an image for displaying the screen 800.

For example, for a state 802 changed from the state 801, the at least one third processing circuitry 213 may, while the inactive state of the first processing circuitry 211 is maintained, control the second processing circuitry 212 so that the screen 800 displayed on the display 231 has a second brightness level lower than the first brightness level. For example, the at least one third processing circuitry 213 may, while the inactive state of the first processing circuitry 211 is maintained, control the second processing circuitry 212 to transmit, to the display 231, a command for the second brightness level, in order to change the state 801 to the state 802. For example, the at least one third processing circuitry 213, while the inactive state of the first processing circuitry 211 is maintained, may control the second processing circuitry 212 to set a brightness level (or grayscale value) of the image for displaying the screen 800 to a brightness level corresponding to the second brightness level, in order to change the state 801 to the state 802.

As a non-limiting example, the at least one third processing circuitry 213 may, while the inactive state of the first processing circuitry 211 is maintained, control the second processing circuitry 212 to maintain a brightness level of a portion (e.g., a visual object 803) of the screen 800. For example, the at least one third processing circuitry 213 may control, while the inactive state of the first processing circuitry 211 is maintained, the second processing circuitry 212 to obtain, from the volatile memory 221, a candidate image corresponding to the visual object 803. For example, the at least one third processing circuitry 213 may control the second processing circuitry 212 to set a brightness level of the candidate image differently from a brightness level of another candidate image used as a background of the screen 800, while the inactive state of the first processing circuitry 211 is maintained. For example, the at least one third processing circuitry 213 may control the second processing circuitry 212 to obtain an image by compositing the candidate image (e.g., the visual object 803) and the other candidate image (e.g., an image for displaying the screen 800 in the state 802), while the inactive state of the first processing circuitry 211 is maintained. For example, the at least one third processing circuitry 213 may control the second processing circuitry 212 to transmit, to the display 231, information regarding the image (or information associated with the image), while the inactive state of the first processing circuitry 211 is maintained.

As a non-limiting example, before the first processing circuitry 211 is in the inactive state, the first processing circuitry 211 may transmit, to the at least one third processing circuitry 213, information for setting a first brightness level of a portion of a background of the screen 800 differently from a second brightness level of another portion of the background of the screen 800. The first processing circuitry 211 may change a state of the first processing circuitry 211 to the inactive state, after transmitting the information. The at least one third processing circuitry 213 may control the second processing circuitry 212 to change a brightness level of the screen 800 based on the information, while the first processing circuitry 211 is in the inactive state and the display 231 operates as the first state. For example, according to the change, the first brightness level of the portion of the background of the screen 800 may be different from the second brightness level of the other portion of the background of the screen 800. As a non-limiting example, the first brightness level may be higher than the second brightness level. As a non-limiting example, the first brightness level may be lower than the second brightness level. For example, a difference between the first brightness level and the second brightness level may be used to indirectly indicate a current time (or local time) or indirectly indicate weather. However, it is not limited thereto.

FIG. 9 illustrates a method of changing a color temperature of a screen displayed on a display operating as a state for lower power consumption according to an embodiment of the disclosure.

Referring to FIG. 9, the at least one third processing circuitry 213 may control the second processing circuitry 212 to change a color temperature (or color tone) of a screen 800 displayed on the display 231 operating as the first state, while the inactive state of the first processing circuitry 211 is maintained.

For example, in a state 901, the at least one third processing circuitry 213 may, while the inactive state of the first processing circuitry 211 is maintained, control the second processing circuitry 212 so that the screen 800 displayed on the display 231 operating as the first state has a first color temperature. For example, the first color temperature may be set based on a command provided from the second processing circuitry 212 to the display driver circuitry 232. For example, for the state 901, the at least one third processing circuitry 213 may control the second processing circuitry 212 to transmit the command to the display 231, while the inactive state of the first processing circuitry 211 is maintained. For example, the first color temperature may also be set by controlling the second processing circuitry 212 to change a color temperature (or grayscale value) of an image for displaying the screen 800.

For example, for a state 902 changed from the state 901, the at least one third processing circuitry 213 may, while the inactive state of the first processing circuitry 211 is maintained, control the second processing circuitry 212 so that the screen 800 displayed on the display 231 has a second color temperature lower than the first color temperature. For example, the at least one third processing circuitry 213 may control, while the inactive state of the first processing circuitry 211 is maintained, the second processing circuitry 212 to transmit a command for the second color temperature to the display 231, in order to change the state 901 to the state 902. For example, the at least one third processing circuitry 213 may control, while the inactive state of the first processing circuitry 211 is maintained, the second processing circuitry 212 to set a color temperature (or grayscale value) of the image for displaying the screen 800 to a color temperature corresponding to the second color temperature, in order to change the state 901 to the state 902.

As a non-limiting example, the at least one third processing circuitry 213 may control the second processing circuitry 212 to maintain a color temperature of a portion (e.g., the visual object 803) of the screen 800, while the inactive state of the first processing circuitry 211 is maintained. For example, the at least one third processing circuitry 213 may control the second processing circuitry 212 to obtain, from the volatile memory 221, a candidate image corresponding to the visual object 803, while the inactive state of the first processing circuitry 211 is maintained. For example, the at least one third processing circuitry 213 may control the second processing circuitry 212 to set a color temperature of the candidate image differently from a color temperature of another candidate image used as a background of the screen 800, while the inactive state of the first processing circuitry 211 is maintained. For example, the at least one third processing circuitry 213 may control the second processing circuitry 212 to obtain an image by compositing the candidate image and the other candidate image, while the inactive state of the first processing circuitry 211 is maintained. For example, the at least one third processing circuitry 213 may control the second processing circuitry 212 to transmit, to the display 231, information regarding the image (or information associated with the image), while the inactive state of the first processing circuitry 211 is maintained.

The operations of the components of the electronic device 200 exemplified above may be executed by the components of the electronic device 100 exemplified in the descriptions of FIGS. 10 and 11.

FIG. 10 is a block diagram illustrating an electronic device 1001 in a network environment 1000 according to an embodiment of the disclosure. Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter wave (mm Wave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (loT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

FIG. 11 is a block diagram 1100 illustrating the display module 1060 according to an embodiment of the disclosure. Referring to FIG. 11, the display module 1060 may include a display 1110 and a display driver integrated circuit (DDI) 1130 to control the display 1110. The DDI 1130 may include an interface module 1131, memory 1133 (e.g., buffer memory), an image processing module 1135, or a mapping module 1137. The DDI 1130 may receive image information that contains image data or an image control signal corresponding to a command to control the image data from another component of the electronic device 1001 via the interface module 1131. For example, according to an embodiment, the image information may be received from the processor 1020 (e.g., the main processor 1021 (e.g., an application processor)) or the auxiliary processor 1023 (e.g., a graphics processing unit) operated independently from the function of the main processor 1021. The DDI 1130 may communicate, for example, with touch circuitry 1150 or the sensor module 1076 via the interface module 1131. The DDI 1130 may also store at least part of the received image information in the memory 1133, for example, on a frame by frame basis. The image processing module 1135 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1110. The mapping module 1137 may generate a voltage value or a current value corresponding to the image data pre-processed or post-processed by the image processing module 1135. According to an embodiment, the generating of the voltage value or current value may be performed, for example, based at least in part on one or more attributes of the pixels (e.g., an array, such as a red green blue (RGB) stripe or a pentile structure, of the pixels, or the size of each subpixel). At least some pixels of the display 1110 may be driven, for example, based at least in part on the voltage value or the current value such that visual information (e.g., a text, an image, or an icon) corresponding to the image data may be displayed via the display 1110.

According to an embodiment, the display module 1060 may further include the touch circuitry 1150. The touch circuitry 1150 may include a touch sensor 1151 and a touch sensor IC 1153 to control the touch sensor 1151. The touch sensor IC 1153 may control the touch sensor 1151 to sense a touch input or a hovering input with respect to a certain position on the display 1110. To achieve this, for example, the touch sensor 1151 may detect (e.g., measure) a change in a signal (e.g., a voltage, a quantity of light, a resistance, or a quantity of one or more electric charges) corresponding to the certain position on the display 1110. The touch circuitry 1150 may provide input information (e.g., a position, an area, a pressure, or a time) indicative of the touch input or the hovering input detected via the touch sensor 1151 to the processor 1020. According to an embodiment, at least part (e.g., the touch sensor IC 1153) of the touch circuitry 1150 may be formed as part of the display 1110 or the DDI 1130, or as part of another component (e.g., the auxiliary processor 1023) disposed outside the display module 1060.

According to an embodiment, the display module 1060 may further include at least one sensor (e.g., a fingerprint sensor, an iris sensor, a pressure sensor, or an illuminance sensor) of the sensor module 1076 or a control circuit for the at least one sensor. In such a case, the at least one sensor or the control circuit for the at least one sensor may be embedded in one portion of a component (e.g., the display 1110, the DDI 1130, or the touch circuitry 1150)) of the display module 1060. For example, when the sensor module 1076 embedded in the display module 1060 includes a biometric sensor (e.g., a fingerprint sensor), the biometric sensor may obtain biometric information (e.g., a fingerprint image) corresponding to a touch input received via a portion of the display 1110. As another example, when the sensor module 1076 embedded in the display module 1060 includes a pressure sensor, the pressure sensor may obtain pressure information corresponding to a touch input received via a partial or whole area of the display 1110. According to an embodiment, the touch sensor 1151 or the sensor module 1076 may be disposed between pixels in a pixel layer of the display 1110, or over or under the pixel layer.

The operations of the components of the electronic device 200 described above may be expressed as follows.

For example, an electronic device (e.g., the electronic device 200) may comprise a display (e.g., the display 231), volatile memory (e.g., the volatile memory 221), a sensor (e.g., the sensor 243), and one or more processors (e.g., the one or more processors 201) comprising first processing circuitry (e.g., the first processing circuitry 211), second processing circuitry (e.g., the second processing circuitry 212), and at least one third processing circuitry (e.g., the at least one third processing circuitry 213). The first processing circuitry may be configured to store, in the volatile memory, candidate images for at least partially changing of a screen to be displayed on the display operating as a state for lower power consumption, wherein storing of the candidate images is performed for maintaining an inactive state of the first processing circuitry while the display operates in the state, and after the candidate images are stored, switch a state of the first processing circuitry to the inactive state.

The at least one third processing circuitry may be configured to, while the inactive state of the first processing circuitry is maintained, control the second processing circuitry to obtain a candidate image corresponding to sensing data obtained via the sensor from among the candidate images, from the volatile memory, and control the second processing circuitry to transmit data associated with the candidate image to the display for at least partially changing the screen being displayed on the display operating in the state based on the candidate image.

For example, the first processing circuitry may be configured to control the second processing circuitry to transmit data regarding an image for the screen to the display, the image for the screen to be initially displayed on the display operating in the state, and based on controlling the second processing circuitry to transmit the data regarding the image and storing the candidate images, switch a state of the first processing circuitry to the inactive state. For example, the image at least partially may correspond to a candidate image from among the candidate images.

For example, the first processing circuitry may be configured to, further based on activating the at least one third processing circuitry, switch a state of the first processing circuitry to the inactive state.

For example, the at least one third processing circuitry may be configured to, while the inactive state of the first processing circuitry is maintained, control the second processing circuitry to obtain, from the volatile memory, another candidate image used as a background of the screen from among the candidate images; control the second processing circuitry to transmit, to the display, other data regarding the other candidate image, for displaying the screen on the display operating in the state; while the screen is, based on the other data, displayed on the display operating in the state, control the second processing circuitry to obtain, from the volatile memory, the candidate image; control the second processing circuitry to obtain an image by adding the candidate image into the other candidate image; and control the second processing circuitry to transmit, to the display, data regarding the image as the data associated with the candidate image.

For example, the at least one third processing circuitry may be configured to, while the inactive state of the first processing circuitry is maintained, control the second processing circuitry to upscale the other candidate image; and control the second processing circuitry to obtain the image by adding the candidate image into the other candidate image upscaled.

For example, the at least one third processing circuitry may be configured to, while the inactive state of the first processing circuitry is maintained, control the second processing circuitry to obtain an image by upscaling the candidate image; and control the second processing circuitry to transmit, to the display, data regarding the image as the data associated with the candidate image.

For example, the candidate images may include another candidate image used as a background of the screen. For example, the at least one third processing circuitry may be configured to, while the inactive state of the first processing circuitry is maintained, for displaying the screen having a background partially changed in accordance with a cycle on the display operating in the state, control the second processing circuitry to change, based on the cycle, a portion of the other candidate image obtained from the volatile memory by accessing the volatile memory using address information changed in accordance with the cycle; and control the second processing circuitry to transmit, to the display, data associated with the portion of the other candidate image, based on the cycle.

For example, the at least one third processing circuitry may be configured to, while the inactive state of the first processing circuitry is maintained, control the second processing circuitry to obtain, from the volatile memory, the candidate image; control the second processing circuitry to obtain an image by adding the candidate image into the portion of the other candidate image; and control the second processing circuitry to transmit, to the display, data regarding the image as the data associated with the candidate image.

For example, the candidate images may include other candidate images concatenated for animation. For example, the at least one third processing circuitry may be configured to, while the inactive state of the first processing circuitry is maintained, control the second processing circuitry to obtain, from the volatile memory, a first candidate image and a second candidate image subsequent to the first candidate image from among the other candidate images; control the second processing circuitry to obtain an image between the first and second candidate images based on executing an interpolation using the first and second candidate images; and for providing an animation via the screen displayed on the display operating in the state, control the second processing circuitry to sequentially transmit, to the display, data associated with the first candidate image, data associated with the image, and data associated with the second candidate image.

For example, the at least one third processing circuitry may be configured to, while the inactive state of the first processing circuitry is maintained, control the second processing circuitry to obtain, from the volatile memory, the candidate image; and for providing an animation via the screen displayed on the display operating in the state, control the second processing circuitry to transmit the data associated with the candidate image, as sequentially transmitting, to the display, data regarding a first image obtained by adding the candidate image into the first candidate image, data regarding a second image obtained by adding the candidate image to the image, and data regarding a third image obtained by adding the candidate image into the second candidate image.

For example, the at least one third processing circuitry may be configured to, while the inactive state of the first processing circuitry is maintained, control the second processing circuitry to obtain, from the volatile memory, another candidate image used as a background of the screen from among the candidate images; control the second processing circuitry to transmit, to the display, data associated with the other candidate image for displaying the screen on the display operating in the state; and control the second processing circuitry to change a brightness level of the screen displayed on the display operating in the state based on the data associated with the other candidate image.

For example, the at least one third processing circuitry may be configured to, while the inactive state of the first processing circuitry is maintained, control the second processing circuitry to obtain an image by adding the candidate image into the other candidate image; control the second processing circuitry to transmit, to the display, data regarding the image as the data associated with the candidate image; and control the second processing circuitry to change a brightness level of the screen displayed on the display operating in the state, based on the data regarding the image.

For example, the at least one third processing circuitry may be configured to, while the inactive state of the first processing circuitry is maintained, control the second processing circuitry to obtain, from the volatile memory, another candidate image used as a background of the screen from among the candidate images; control the second processing circuitry to transmit, to the display, data associated with the other candidate image, for displaying the screen on the display operating in the state; and control the second processing circuitry to change a color temperature of the screen displayed on the display operating in the state based on the data associated with the other candidate image.

For example, the at least one third processing circuitry may be configured to, while the inactive state of the first processing circuitry is maintained, control the second processing circuitry to obtain an image by adding the candidate image into the other candidate image; control the second processing circuitry to transmit, to the display, data regarding the image as the data associated with the candidate image; and control the second processing circuitry to change a color temperature of the screen displayed on the display operating in the state based on the data regarding the image.

For example, the first processing circuitry may be configured to detect an event for ceasing that the display operates in the state; in response to the event, switch a state of the first processing circuitry from the inactive state to an active state of the first processing circuitry; and in response to switching a state of the first processing circuitry to the active state, control the second processing circuitry to transmit, to the display, data regarding an image corresponding to the screen displayed on the display immediately before the display operating in the state is ceased.

For example, the first processing circuitry may be configured to control the second processing circuitry to maintain transmitting to the display data associated with the image corresponding to the screen displayed on the display immediately before the display operating in the state is ceased, for a reference time from switching to the active state, and the data associated with the image may include the data regarding the image.

For example, maintaining transmitting to the display the data regarding the image may be performed for a gradual change from the screen to another screen displayed in a lock state of the electronic device.

For example, the first processing circuitry may include a central processing unit (CPU), the second processing circuitry may include a display processing unit (DPU), and the at least one third processing circuitry may include at least one of a micro processor unit (MPU) and a sensor hub.

For example, the first processing circuitry may include a big core of a central processing unit (CPU) or a performance core of the CPU, and the at least one third processing circuitry may include a little core of the CPU or an efficiency core of the CPU, and the sensing data may be received from a sensor hub connected to the sensor.

For example, an electronic device may comprise a display, volatile memory, a sensor, and one or more processors. For example, the one or more processors may be configured to, in response to occurrence of an event in which the display operates as a state for lower power consumption, access the volatile memory, by using power within a first range, before the display operates in the state for lower power consumption; after accessing the volatile memory, obtain sensing data from the sensor by using a power within a second range lower than the first range, while displaying a screen on the display operating in the state for lower power consumption; and while a power used by the one or more processors is maintained within the second range, cause a visual object corresponding to the sensing data to appear within the screen displayed on the display operating in the state for lower power consumption, based on accessing the volatile memory in response to the sensing data.

For example, an electronic device may comprise a display, volatile memory, a sensor, and one or more processors. For example, the one or more processors may be configured to store, in the volatile memory, candidate images for at least partially changing of a screen to be displayed on the display operating as a state for lower power consumption, by using a power within a first range; while one or more processors operates by using a power within a second range lower than the first range after storing the candidate images, obtain, from the volatile memory, a candidate image corresponding to sensing data obtained through the sensor from among the candidate images; and at least partially change the screen displayed on the display operating in the state for the lower power consumption by transmitting, to the display, data associated with the candidate image.

For example, an electronic device may comprise a display, volatile memory, a sensor, and one or more processors. The one or more processors may be configured to store, in the volatile memory, candidate images for at least partially changing of a screen to be displayed on the display operating as a state for lower power consumption by using a power within a first range; after storing the candidate images, obtain sensing data through the sensor, while the screen is displayed on the display operating in the state for the lower power consumption and power within a second range lower than the first range is consumed by the one or more processors; obtain, from the volatile memory, a candidate image corresponding to the sensing data from among the candidate images to maintain consumption of the power within the second range; and while the consumption of the power within the second range is maintained, at least partially change the screen displayed on the display operating as the lower power state based on the candidate image.

The technical problems to be achieved in this document are not limited to those described above, and other technical problems not mentioned herein will be clearly understood by those having ordinary knowledge in the art to which the disclosure belongs, from the following description.

The effects that can be obtained from the disclosure are not limited to those described above, and any other effects not mentioned herein will be clearly understood by those having ordinary knowledge in the art to which the disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions;
a sensor; and
one or more processors including first processing circuitry, second processing circuitry, and at least one third processing circuitry,
wherein the instructions, when executed by the first processing circuitry, cause the first processing circuitry to:
store, in the memory, candidate images for at least partially changing a screen to be displayed on the display operating in a state for lower power consumption, wherein storing of the candidate images is performed for maintaining an inactive state of the first processing circuitry while the display operates in the state for lower power consumption, and
after the candidate images are stored, switch a state of the first processing circuitry to the inactive state, and
wherein the instructions, when executed by the at least one third processing circuitry, cause the at least one third processing circuitry to, while the inactive state of the first processing circuitry is maintained:
control the second processing circuitry to obtain a candidate image corresponding to sensing data obtained via the sensor from among the candidate images, from the memory, and
control the second processing circuitry to transmit data associated with the candidate image to the display for at least partially changing the screen being displayed on the display operating in the state for lower power consumption based on the candidate image.

2. The electronic device of claim 1,
wherein the instructions, when executed by the first processing circuitry, further cause the first processing circuitry to:
control the second processing circuitry to transmit data regarding an image for the screen to the display, the image for the screen to be initially displayed on the display operating in the state for lower power consumption, and
based on controlling the second processing circuitry to transmit the data regarding the image and storing the candidate images, switch a state of the first processing circuitry to the inactive state, and
wherein the image at least partially corresponds to a candidate image from among the candidate images.

3. The electronic device of claim 2, wherein the instructions, when executed by the first processing circuitry, further cause the first processing circuitry to:
further based on activating the at least one third processing circuitry, switch a state of the first processing circuitry to the inactive state.

4. The electronic device of claim 1, wherein the instructions, when executed by the at least one third processing circuitry, further cause the at least one third processing circuitry to, while the inactive state of the first processing circuitry is maintained:
control the second processing circuitry to obtain, from the memory, another candidate image used as a background of the screen from among the candidate images,
control the second processing circuitry to transmit, to the display, other data regarding the other candidate image, for displaying the screen on the display operating in the state for lower power consumption,
while the screen is, based on the other data, displayed on the display operating in the state for lower power consumption, control the second processing circuitry to obtain, from the memory, the candidate image,
control the second processing circuitry to obtain an image by adding the candidate image into the other candidate image, and
control the second processing circuitry to transmit, to the display, data regarding the image as the data associated with the candidate image.

5. The electronic device of claim 4, wherein the instructions, when executed by the at least one third processing circuitry, further cause the at least one third processing circuitry to:
while the inactive state of the first processing circuitry is maintained:
control the second processing circuitry to upscale the other candidate image; and
control the second processing circuitry to obtain the image by adding the candidate image into the other candidate image upscaled.

6. The electronic device of claim 1, wherein the instructions, when executed by the at least one third processing circuitry, further cause the at least one third processing circuitry to, while the inactive state of the first processing circuitry is maintained:
control the second processing circuitry to obtain an image by upscaling the candidate image, and
control the second processing circuitry to transmit, to the display, data regarding the image as the data associated with the candidate image.

7. The electronic device of claim 1,
wherein the candidate images include another candidate image used as a background of the screen, and
wherein the instructions, when executed by the at least one third processing circuitry, further cause the at least one third processing circuitry to, while the inactive state of the first processing circuitry is maintained:
for displaying the screen having a background partially changed in accordance with a cycle on the display operating in the state, control the second processing circuitry to change, based on the cycle, a portion of the other candidate image obtained from the memory by accessing the memory using address information changed in accordance with the cycle; and
control the second processing circuitry to transmit, to the display, data associated with the portion of the other candidate image, based on the cycle.

8. The electronic device of claim 7, wherein the instructions, when executed by the at least one third processing circuitry, further cause the at least one third processing circuitry to, while the inactive state of the first processing circuitry is maintained:
control the second processing circuitry to obtain, from the memory, the candidate image,
control the second processing circuitry to obtain an image by adding the candidate image into the portion of the other candidate image, and
control the second processing circuitry to transmit, to the display, data regarding the image as the data associated with the candidate image.

9. The electronic device of claim 1,
wherein the candidate images include other candidate images concatenated for animation, and
wherein the instructions, when executed by the at least one third processing circuitry, further cause the at least one third processing circuitry to, while the inactive state of the first processing circuitry is maintained:
control the second processing circuitry to obtain, from the memory, a first candidate image and a second candidate image subsequent to the first candidate image from among the other candidate images,
control the second processing circuitry to obtain an image between the first and second candidate images based on executing an interpolation using the first and second candidate images, and
for providing an animation via the screen displayed on the display operating in the state for lower power consumption, control the second processing circuitry to sequentially transmit, to the display, data associated with the first candidate image, data associated with the image, and data associated with the second candidate image.

10. The electronic device of claim 9, wherein the instructions, when executed by the at least one third processing circuitry, further cause the at least one third processing circuitry to, while the inactive state of the first processing circuitry is maintained:
control the second processing circuitry to obtain, from the memory, the candidate image, and
for providing an animation via the screen displayed on the display operating in the state for lower power consumption, control the second processing circuitry to transmit the data associated with the candidate image, as sequentially transmitting, to the display, data regarding a first image obtained by adding the candidate image into the first candidate image, data regarding a second image obtained by adding the candidate image to the image, and data regarding a third image obtained by adding the candidate image into the second candidate image.

11. The electronic device of claim 1, wherein the instructions, when executed by the at least one third processing circuitry, further cause the at least one third processing circuitry to, while the inactive state of the first processing circuitry is maintained:
control the second processing circuitry to obtain, from the memory, another candidate image used as a background of the screen from among the candidate images,
control the second processing circuitry to transmit, to the display, data associated with the other candidate image for displaying the screen on the display operating in the state for lower power consumption, and
control the second processing circuitry to change a brightness level of the screen displayed on the display operating in the state for lower power consumption based on the data associated with the other candidate image.

12. The electronic device of claim 11, wherein the instructions, when executed by the at least one third processing circuitry, further cause the at least one third processing circuitry to, while the inactive state of the first processing circuitry is maintained:
control the second processing circuitry to obtain an image by adding the candidate image into the other candidate image,
control the second processing circuitry to transmit, to the display, data regarding the image as the data associated with the candidate image, and
control the second processing circuitry to change a brightness level of the screen displayed on the display operating in the state for lower power consumption, based on the data regarding the image.

13. The electronic device of claim 1, wherein the instructions, when executed by the at least one third processing circuitry, further cause the at least one third processing circuitry to, while the inactive state of the first processing circuitry is maintained:
control the second processing circuitry to obtain, from the memory, another candidate image used as a background of the screen from among the candidate images,
control the second processing circuitry to transmit, to the display, data associated with the other candidate image, for displaying the screen on the display operating in the state for lower power consumption, and
control the second processing circuitry to change a color temperature of the screen displayed on the display operating in the state for lower power consumption based on the data associated with the other candidate image.

14. The electronic device of claim 13, wherein the instructions, when executed by the at least one third processing circuitry, further cause the at least one third processing circuitry to, while the inactive state of the first processing circuitry is maintained:
control the second processing circuitry to obtain an image by adding the candidate image into the other candidate image,
control the second processing circuitry to transmit, to the display, data regarding the image as the data associated with the candidate image, and
control the second processing circuitry to change a color temperature of the screen displayed on the display operating in the state for lower power consumption based on the data regarding the image.

15. The electronic device of claim 1, wherein the instructions, when executed by the first processing circuitry, further cause the first processing circuitry to:
detect an event for ceasing that the display operates in the state for lower power consumption,
in response to the event, switch a state of the first processing circuitry from the inactive state to an active state of the first processing circuitry, and
in response to switching a state of the first processing circuitry to the active state, control the second processing circuitry to transmit, to the display, data regarding an image corresponding to the screen displayed on the display immediately before the display ceases operating in the state for lower power consumption.

16. The electronic device of claim 15,
wherein the instructions, when executed by the first processing circuitry, further cause the first processing circuitry to control the second processing circuitry to maintain transmitting, to the display, data associated with the image corresponding to the screen displayed on the display immediately before the display ceases operating in the state for lower power consumption, for a reference time from switching to the active state, and
wherein the data associated with the image includes the data regarding the image.

17. The electronic device of claim 16, wherein maintaining transmitting to the display the data regarding the image is performed for a gradual change from the screen to another screen displayed in a lock state of the electronic device.

18. The electronic device of claim 1,
wherein the first processing circuitry comprises a central processing unit (CPU),
wherein the second processing circuitry comprises a display processing unit (DPU), and
wherein the at least one third processing circuitry comprises at least one of a micro processor unit (MPU) and a sensor hub.

19. The electronic device of claim 1,
wherein the first processing circuitry comprises a big core of a central processing unit (CPU) or a performance core of the CPU,
wherein the at least one third processing circuitry comprises a little core of the CPU or an efficiency core of the CPU, and
wherein the sensing data is received from a sensor hub connected to the sensor.

20. An electronic device comprising:
a display,
volatile memory, including one or more storage media, storing instructions,
a sensor, and
one or more processors,
wherein the instructions, when executed by the one or more processors individually or collectively, cause the electronic device to:
in response to occurrence of an event in which the display operates in a state for lower power consumption, access the volatile memory, by using power within a first range, before the display operates in the state for lower power consumption;
after accessing the volatile memory, obtain sensing data from the sensor by using a power within a second range lower than the first range, while displaying a screen on the display operating in the state for lower power consumption; and
while a power used by the one or more processors is maintained within the second range, cause a visual object corresponding to the sensing data to appear within the screen displayed on the display operating in the state for lower power consumption, based on accessing the volatile memory in response to the sensing data.
